(19) United States
(12) Patent Application Publication
(10) Pub. No.: US 2008/0167189 A1
(43) Pub. Date: Jul. 10, 2008

(54) Polymer Compositions and Their Use in the Production of Active or Effective Ingredient Compositions

(75) Inventors: Guenter Oetter, Frankenthal (DE); Christian Kruger, Saulheim (DE); Norbert Wagner, Mutterstadt (DE); Matthias Bratz, Maxdorf (DE); Rainer Berghaus, Speyer (DE); Peter Dombo, Wiesbaden (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 11/815,567

(22) PCT Filed: Feb. 8, 2006
(86) PCT No.: PCT/EP06/01106

§ 371 Date: Aug. 6, 2007

(30) Foreign Application Priority Data
Feb. 9, 2005 (DE) 10 2005 005 931.7

(51) Int. Cl. A01N 25/00; C08F 8/30; A01P 3/00; A01P 13/00; A01P 7/00; A01N 25/10

(52) U.S. Cl. 504/360; 525/123; 514/772.3; 424/501

(57) ABSTRACT

The present invention relates to polymer compositions, to a process for their preparation and to their use for preparing aqueous active compound compositions of water-insoluble active compounds, in particular of active compounds for crop protection.

The present invention relates to novel polymer compositions, to a process for their preparation and to their use for stabilizing water-insoluble or poorly water-soluble active compounds or effect substances in an aqueous phase and for preparing active compound compositions of water-insoluble active compounds or effect substances, in particular of active compounds for crop protection.

Active compounds, i.e. substances capable of exerting a physiological action even at low concentration, are frequently used or formulated in the form of aqueous active compound compositions. Thus, for example, active compounds used in crop protection for controlling pests, i.e. insecticides, fungicides and herbicides, but also growth regulators, are frequently formulated and sold as concentrates, e.g. aqueous concentrates such as suspensions or emulsions, but also as solid concentrates such as powders, dusts or granules, which, prior to their application, are diluted to the desired application concentration by adding a large amount of water (“spray liquor”). Aqueous active compound compositions have also proven themselves to be useful for pharmaceutically and cosmetically active substances and for food additives, for example vitamins, provitamins, etc. The same applies to the formulation of effect substances, i.e. low-molecular-weight compounds which exert a defined technical action even at a low application rate, for example colorants and UV stabilizers.

A general problem in the case of aqueous active compound compositions is the generally poor solubility of the active compounds in water, which is frequently less than 10 g/l at 23° C./1013 mbar. Accordingly, aqueous formulations of such active compounds and also aqueous ready-to-use preparations are heterogeneous systems where the active compound is present as an emulsified and/or dispersed phase in a continuous aqueous phase. For stabilizing these systems, which are metastable per se, it is customary to employ emulsifiers or dispersants. However, their stabilizing action is frequently unsatisfactory, so that the active compound may separate out, for example cream or sediment, in particular if the aqueous formulation is stored for a relatively long period of time at elevated temperature and/or at highly variable temperatures or close to freezing point. This problem is particularly pronounced if the active compound has a tendency to crystallize. The precipitation of solid active compound particles also frequently occurs when a formulation which comprises the active compound in concentrated form is diluted with water.

Organic solvents are frequently used for preparing formulations of water-insoluble active compounds. Thus, water-miscible solvents are frequently used as solubilizers, i.e. to increase the solubility of the active compound or effect substance in the aqueous phase. Water-immiscible solvents, in turn, serve to convert an active compound which is solid at the application temperature into a liquid phase which can then be emulsified more easily. In contrast to suspensions of the solid active compound, in the emulsions the active compound is dissolved in the solvent droplets in molecular form and is thus more readily available and therefore more effective on application. However, owing to the known problems caused by VOC, the use of large amounts of organic solvents is, for reasons related to work hygiene, because of environmental aspects and in some cases also for toxicological reasons, not desirable.

A further disadvantage of conventional aqueous active compound compositions is the relatively large particle size of the active compound particles and active compound droplets suspended and emulsified, respectively, in the aqueous phase, whose size is generally in the region of several μm. However, what is desired are aqueous formulations in which the active compound is present in the most highly dispersed form possible or is converted into a highly dispersed form on dilution with water, firstly to ensure uniform distribution in the formulation and thus better handling and dosing properties and to increase simultaneously the bioavailability of the active compound in the formulation or in the ready-to-use composition. What is desired here are formulations which, on dilution with water, provide an active compound composition in which the mean particle size in the active-compound-comprising phase is below 500 nm and in particular below 300 nm.

There have been various proposals to use amphiphilic block copolymers for solubilizing water-insoluble active compounds in an aqueous vehicle. The term “solubilization” refers to a stable, uniform distribution of the water-insoluble active compound or effect substance in the aqueous phase achieved by using solubility-conveying substances (auxiliaries), where the particles of the disperse active compound phase are frequently so small that they hardly scatter visible light and the mixture therefore appears to be more or less transparent. Here, the amphiphilic block copolymers generally comprise at least one hydrophilic polymer block and at least one hydrophobic polymer block.

Thus, for example, US 2003/0009004 proposes for this purpose amphiphilic block copolymers comprising a hydrophilic polyethyleneimine block and a hydrophobic block of a biodegradable aliphatic polyester. However, this has the disadvantage that relatively large amounts of polymer, based on the active compound, are required to achieve stable aqueous active compound compositions.

US 2003/0157170 describes water-free active compound compositions comprising an amphiphilic diblock copolymer having a polyester as hydrophobic component and an additive. On dilution with water, the compositions form active compound-containing micelles. These compositions, too, have the disadvantage that relatively large amounts of polymer are required to stabilize the active compound in the aqueous phase.

WO 02/82900 describes the use of amphiphilic block copolymers for preparing aqueous suspensions of water-insoluble crop protection agents. The block copolymers used can be obtained by “living” or “controlled” free-radical block copolymerization of ethylenically unsaturated monomers. In addition to the fact that such processes are relatively complicated, the aqueous active compound formulations comprise relatively large amounts of water-soluble organic solvents. Moreover, the process requires the use of toxic transition metal catalysts which remain in the product. Moreover, the color of the block copolymers tends to change to brown.

To summarize, it may be stated that, in spite of the general advantages offered for the formulation of water-insoluble active compounds and effect substances by block copolymers, the block copolymers known from the prior art are not entirely satisfactory, whether because their preparation is very complicated, the stability of the aqueous active compound formulations or active compound preparations is unsatisfactory, the activity of the active compounds is adversely affected or large amounts of polymer are required to stabilize the active compound in the aqueous phase, which, in addition to higher costs, may also be disadvantageous when using such preparations.

Accordingly, it is an object of the present invention to provide substances which enable effective solubilization of water-insoluble active compounds in an aqueous medium. These substances should be suitable for preparing formulations which permit an effective stabilization of the active compound in the aqueous phase. In particular, these substances should also be suitable for providing aqueous active compound compositions of water-insoluble active compounds, which compositions have a very low content, if any, of volatile organic compounds. Furthermore, it is desirable that the aqueous active compound compositions prepared using these substances have high stability with respect to breakdown on prolonged storage, when electrolytes are added and during dilution with water.

Surprisingly, this object is achieved by a polymer composition, obtainable by reacting
a) at least one polymer P1 which carries functional groups R1 which are reactive toward isocyanate groups and which is constructed of ethylenically unsaturated monomers M1, where the monomers M1 comprise more than 20% by weight, based on the total amount of monomers M1, of monomers M1a having at least one functional group FG selected from the group consisting of tertiary amino groups, imino groups, carboxamide groups, nitrile groups, lactam groups, keto groups, aldehyde groups, urea groups, polyether groups, carboxyl groups, sulfonyl groups, hydroxysulfonyl groups and sulfonamide groups,
b) at least one poly-C₂-C₄-alkylene ether P2 which carries functional groups R2 which are reactive toward isocyanate groups,
c) with at least one compound V which comprises isocyanate groups and, with respect to the isocyanate groups, has a functionality of at least 1.5.

Accordingly, the present invention relates to the polymer compositions described herein and to the process for their preparation.

In an advantageous manner, the polymer compositions according to the invention are suitable for stabilizing active compounds and effect substances, which are poorly soluble in water, if at all, in aqueous phase, thereby making it possible to prepare aqueous formulations of such active compounds and effect substances, and the preparation of nonaqueous formulations which, on dilution with water, lead to an extremely highly dispersed distribution of the active compound or effect substance in the aqueous phase. In contrast to the block copolymers described in the prior art, they can be used to solubilize large amounts of active compound, based on the polymer, stably in the aqueous phase.

Accordingly, the present invention also provides the use of the polymer compositions described here and below for stabilizing active compounds and/or effect substances, which are poorly soluble or insoluble in water, in an aqueous medium.

Furthermore, the present invention provides the use of the polymer compositions described herein for preparing formulations of water-insoluble or poorly water-soluble active compounds and effect substances. In this context, poor solubility is a solubility of the active compound or effect substance in water of less than 10 g/l, frequently less than 5 g/l and in particular less than 1 g/l and especially less than 0.1 g/l, at 25° C. and 1013 mbar.

The present invention also provides active compound and effect substance compositions which comprise at least one poorly water-soluble or water-insoluble active compound and/or effect substance and at least one polymer composition according to the invention as described here and below.

The active compound or effect substance compositions according to the invention may be solid or liquid. A preferred embodiment of such a composition relates to an aqueous, that is to say liquid, active compound composition which has an aqueous medium as continuous phase and at least one disperse phase, the disperse phase comprising at least one active compound and/or effect substance having a solubility in water at 25° C./1013 mbar of less than 10 g/l, and at least one polymer composition according to the invention.

The aqueous active compound compositions, prepared using the polymer compositions according to the invention, of water-insoluble active compounds or effect substances comprise, in addition to an aqueous medium as continuous phase, at least one active compound- and/or effect substance-containing phase, in which the active compound or effect substance and the amphiphilic polymer composition are present in the form of aggregates consisting of active compound or effect substance and the polymer constituents of the polymer composition according to the invention. This active compound- or effect substance-containing phase consequently forms a disperse phase comprising the active compound or the effect substance and at least one polymer composition according to the invention.

In the continuous aqueous phase, the active compound is present is present in an extremely finely divided form, which may even be a molecularly dissolved form. It is thought that in the aqueous phase, the active compound forms aggregates with the amphiphilic polymer composition according to the invention. In general, these aggregates have mean particle sizes of less than 1 μm, frequently less than 500 nm, in particular less than 400 nm, especially less than 300 nm and very especially less than 200 nm. Depending on the nature of the polymer and of the active compound or effect substance and depending on the concentration ratios, the aggregates may even be so small that they are no longer present in the form of detectable discrete particles but in dissolved form (particle size <20 nm or <5 nm). If the aggregates are present in the form of discrete particles, the mean particle size of the particles is frequently in the range from 5 to 400 nm, preferably in the range from 10 to 300 nm and particularly preferably in the range from 20 to 200 nm.

A further preferred embodiment of the invention relates to a nonaqueous, generally solid or semisolid active compound composition comprising at least one active compound and/or effect substance having a solubility in water at 25° C./1013 mbar of less than 10 g/l, and at least one amphiphilic polymer composition, and comprising substantially no water or only small amounts, that is to say <10% by weight of water. These compositions may comprise, as further constituents, the auxiliaries and additives which are typical of the respective application purpose.

The compositions according to the invention, that is to say both aqueous and nonaqueous compositions, provide preparations of the active compound or effect substance which are aqueous on dilution, comprising an aqueous, continuous phase and at least one active compound- or effect substance-containing phase having mean particle sizes significantly less than 1 μm, typically not more than 500 nm, frequently not more than 300 nm, in particular not more than 200 nm or 150 nm and especially not more than 100 nm, for example in the range from 10 to 300 nm, preferably in the range from 10 to 250 nm, in particular in the range from 20 to 200 nm or 20 to 150 nm and particularly preferably in the range from 30 to 100 nm.

The stated particle sizes are weight-average particle sizes which can be determined by dynamic light scattering. The person skilled in the art is familiar with methods to achieve this, for example from H. Wiese in D. Distler, Wässrige Polymerdispersionen [Aqueous Polymer Dispersions], Wiley-VCH 1999, chapter 4.2.1, p. 40ff. and the literature cited therein, and also H. Auweter, D. Horn, J. Colloid Interf. Sci. 105 (1985) 399, D. Lilge, D. Horn, Colloid Polym. Sci. 269 (1991) 704 or H. Wiese, D. Horn, J. Chem. Phys. 94 (1991) 6429.

Here and below, the terms “aqueous medium” and “aqueous phase” include water, aqueous mixtures of water with up to 10% by weight, based on the mixture, of water-miscible organic solvents, and solutions of solids in water or in the aqueous mixtures. Examples of water-miscible solvents comprise C₃-C₄ ketones, such as acetone and methyl ethyl ketone, cyclic ethers, such as dioxane and tetrahydrofuran, C₁-C₄-alkanols, such as methanol, ethanol, n-propanol, isopropanol, n-butanol, tert-butanol, polyols and their mono- and dimethyl ethers, such as glycol, propanediol, ethylene glycol monomethyl ether, diethylene glycol, diethylene glycol monomethyl ether, diethylene glycol dimethyl ether, glycerol, furthermore C₂-C₃-nitriles, such as acetonitrile and propionitrile, dimethyl sulfoxide, dimethylformamide, formamide, acetamide, dimethylacetamide, butyrolactone, 2-pyrrolidone and N-methylpyrrolidone.

Here and below, the term “functionality” denotes the mean number of the respective functional groups R1 or R2 per molecule or per polymer chain.

Here and below, the term active compound composition is synonymously used with the term formulation and preparation, that is to say in the context of a composition which comprises the active compound in concentrated form and which, if appropriate, is diluted to the desired use concentration for use with water or aqueous liquids.

The aqueous active compound compositions according to the invention but also the active compound compositions according to the invention obtained by dilution of an aqueous or nonaqueous active compound composition with water have extremely high stability to breakdown. Without breakdown occurring, they can be stored over a relatively long period of time of several months, even at elevated temperature and/or at highly variable temperatures. Additionally, without any problems, more concentrated preparations can also be diluted with water without any breakdown phenomena, such as coagulation, crystallization, flocculation or sedimentation, taking place. Moreover, the compositions are highly tolerant to electrolytes. Additionally, owing to the extremely fine distribution, as a result of the very small apparent particle diameter of the active compound/effect substance aggregates, the activity of the active compounds or the activity of the effect substances is increased compared to conventional formulations. A further advantage of the active compound compositions according to the invention is that they can also be formulated as low-solvent compositions (content of volatile solvents <10% by weight, based on the weight of the active compound composition) or even as solvent-free compositions (content of volatile solvents <1% by weight, based on the weight of the active compound composition).

A further advantage of the polymer compositions according to the invention is the fact that the active compounds can be formulated in solid form. For example, the liquid active compound compositions according to the invention, for example aqueous active compound compositions but also solutions of the active compound or effect substance and the polymer composition in an organic solvent can be dried to give a redispersible solid material, such as, for example, a powder or granules. This means that, by removing the aqueous phase or the organic solvent during drying, depending on the drying conditions, finely divided powders or coarse granules are obtained which can be dissolved or dispersed in water without any problems and without any particle size increase worth mentioning occurring.

A further advantage of the amphiphilic polymers is the fact that, depending on the nature of the polymer composition, the solubilizing properties can be controlled via the pH. If, for example, the polymer P1 has carboxyl groups, it is possible to reduce the solubilizing action by increasing the pH, which may result in a spontaneous release of the active compound. In turn, if the polymer comprises basic groups, the solubilization can be reduced by reducing the pH.

Both the polymers P1 used for preparing the polymer composition according to the invention and the poly-C₂-C₄-alkylene ethers P2 have functional groups R1 and R2, respectively, which are reactive toward isocyanate groups and react with the isocyanate group of the compound V, forming bonds. Examples of suitable functional groups are hydroxyl groups, mercapto groups (SH) and primary and secondary amino groups. Preferred functional groups are hydroxyl groups, in particular hydroxyl groups attached to an aliphatic or cycloaliphatic carbon atom.

Since the isocyanate group-containing compound V has, on average, at least 1.5 isocyanate groups per molecule, in the reaction of V with the polymer P1 and the poly-C₂-C₄-alkylene ether P2 at least some block copolymers are formed comprising both at least one polymer block derived from the polymer P1 and at least one hydrophilic polymer block, different therefrom, derived from the poly-C₂-C₄-alkylene ether P2. In contrast to the amphiphilic block copolymers of the prior art, the blocks are attached to one another not directly but via a linker which has at least two urethane and/or urea groups. In contrast to the block copolymers of the prior art, the polymer compositions obtained generally also comprise minor amounts of unreacted polymers P1 and/or P2 and also symmetrical reaction products having either polymer blocks derived exclusively from polymers P1 or polymer blocks derived exclusively from poly-C₂-C₄-alkylene ethers P2. However, the advantageous properties of the polymer composition remain ensured.

It is thought that, by virtue of the affinity of the functional groups FG present in the polymer blocks P1 to the active compounds or effect substances, the block copolymers in the polymer compositions according to the invention form aggregates with the active compounds in the aqueous phase. It is also thought that the polymer blocks P1 together with the active compounds form the center of these aggregates, whereas the hydrophilic polyether chains P2 form the external regions of the aggregates, thus stabilizing the aggregates in aqueous media. The affinity of the functional groups FG to the active compound to be formulated can be based, for example, on ionic interactions, on nonionic dipole-dipole interactions, on hydrogen bonds, on interactions of π systems or else on mixed forms of these interactions.

Suitable polymers P1 are, in principle, all polymers constructed of ethylenically unsaturated monomers M1, which polymers comprise the required number of reactive groups R1 and whose constituting monomers M1 comprise more than 20% by weight, in particular at least 25% by weight, particularly preferably at least 30% by weight and very particularly preferably at least 35% by weight of the functionalized monomers M1a. The proportion of monomers M1a in the monomers M1 may be up to 100% by weight and is advantageously in the range from 25 to 90% by weight, in particular in the range from 30 to 80% by weight, particularly preferably in the range from 30 to 70% by weight and very particularly preferably in the range from 35 to 60% by weight.

According to the invention, the monomers M1a have, in addition to the ethylenically unsaturated double bond, one or more, for example one or two, functional groups FG. In general, these increase the solubility in water of the monomers M1a. Accordingly, frequently, the solubility in water of the monomers M1a is at least 50 g/l and in particular at least 80 g/l at 25° C. and 1013 mbar. The monomers M1a may be either acidic or anionic or basic or neutral.

In a first preferred embodiment, the monomers M1a comprise substantially only neutral monomers M1a.

In a second preferred embodiment, the monomers M1a comprise substantially only basic monomers M1a.

In a third preferred embodiment, the monomers M1a comprise substantially only acidic monomers M1a.

In a fourth preferred embodiment of the invention, the monomers M1a comprise substantially a mixture of neutral and basic monomers M1a. In this embodiment, the weight ratio of neutral to basic monomers is preferably in the range from 1:10 to 10:1 and in particular in the range from 5:1 to 1:2.

In a fifth preferred embodiment of the invention, the monomers M1a comprise substantially a mixture of neutral and acidic monomers M1a. In this embodiment, the weight ratio of neutral to acidic monomers is preferably in the range from 1:10 to 10:1 and in particular in the range from 5:1 to 1:2.

Among the embodiments 1 to 5, particular preference is given to the embodiments 1, 2 and 4.

Here, substantially means at least 90% by weight and in particular at least 95% by weight, based on the weight of the monomers M1a.

The neutral monomers M1a include, for example,
amides and C₁-C₄-alkyloxyalkylamides of monoethylenically unsaturated C₃-C₈-monocarboxylic acids, such as acrylamide, methacrylamide, N-(methoxymethyl)(meth)acrylamide, N-(ethoxymethyl)(meth)acrylamide, N-(2-methoxyethyl)(meth)acrylamide, N-(2-ethoxyethyl)(meth)acrylamide and the like;
monoethylenically unsaturated nitriles, such as acrylonitrile and methacrylonitrile;
N-vinylamides of aliphatic, cycloaliphatic or aromatic carboxylic acids, in particular N-vinylamides of aliphatic carboxylic acids having 1 to 4 carbon atoms, such as N-vinylformamide, N-vinylacetamide, N-vinylpropionamide and N-vinylbutyramide;
N-vinyllactams having 5 to 7 ring atoms, for example N-vinylpyrrolidone, N-vinylpiperidone, N-vinylmorpholinone and N-vinylcaprolactam;
monoethylenically unsaturated monomers which carry urea groups, such as N-vinyl- and N-allylurea, and also derivatives of imidazolidin-2-one, for example N-vinyl- and N-allylimidazolidin-2-one, N-vinyloxyethylimidazolidin-2-one, N-allyloxyethylimidazolidin-2-one N-(2-acrylamidoethyl)imidazolidin-2-one, N-(2-acryloxyethyl)imidazolidin-2-one, N-(2-methacrylamidoethyl)imidazolidin-2-one, N-(2-methacryloxyethyl)imidazolidin-2-one (=ureidomethacrylate), N-[2-(acryloxyacetamido)ethyl]imidazolidin-2-one N-[2-(2-acryloxyacetamido)ethyl]imidazolidin-2-one N-[2-(2-methacryloxyacetamido)ethyl]imidazolidin-2-one;
monoethylenically unsaturated monomers which have aldehyde or keto groups, such as 3-(acrylamido)-3-methylbutan-2-one (diacetoneacrylamide), 3-(methacrylamido)-3-methylbutan-2-one, 2,4-dioxapentyl acrylate and 2,4-dioxapentyl methacrylate.

Preferred neutral monomers are N-vinyllactams, in particular N-vinylpyrrolidone, and also monomers which carry urea groups, in particular N-(2-acrylamidoethyl)imidazolin-2-one and N-(2-methacrylamidoethyl)imidazolin-2-one.

The basic monomers M1a include, for example,
vinyl-substituted nitrogen heteroaromatics, such as 2-, 3- and 4-vinylpyridine, N-vinylimidazole; and
monoethylenically unsaturated monomers having a primary, secondary or tertiary amino group, in particular monomers of the formula I

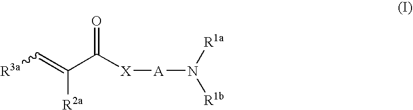

in which
X is oxygen or a group N—R^{4a};
A is C₂-C₈-alkylene, for example 1,2-ethanediyl, 1,2- or 1,3-propanediyl, 1,4-butanediyl or 2-methyl-1,2-propanediyl which, if appropriate, may be interrupted by 1, 2 or 3 non-adjacent oxygen atoms, such as in 3-oxapentane-1,5-diyl;
R^{1a}, R^{1b} independently of one another are hydrogen, C₁-C₁₀-alkyl, C₅-C₁₀-cycloalkyl, phenyl or phenyl-C₁-C₄-alkyl and are in particular both each C₁-C₄-alkyl;
R^{2a} is hydrogen or C₁-C₄-alkyl, in particular hydrogen or methyl;
R^{3a} is hydrogen or C₁-C₄-alkyl and in particular hydrogen; and
R^{4a} is hydrogen or C₁-C₄-alkyl and in particular hydrogen.

Examples of monomers of the formula I are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propyl acrylate, 3-(N,N-dimethylamino)propyl methacrylate, 3-(N,N-dimethylamino)propylacrylamide, 3-(N,N-dimethylamino)propylmethacrylamide and 2-(N,N-dimethylamino)ethylmethacrylamide, 3-(N,N-dimethylamino)propyl methacrylate being particularly preferred.

Preferred basic monomers M1a are the monomers of the general formula I.

The monomers M1a furthermore include anionic or acidic monoethylenically unsaturated monomers. Examples of these are:
monoethylenically unsaturated monomers which have a sulfonic acid group, and the salts of such monomers, in particular the alkali metal salts, for example the sodium or potassium salts, and also the ammonium salts. These include ethylenically unsaturated sulfonic acids, in particular vinylsulfonic acid, 2-acrylamido-2-methylpropanesulfonic acid, 2-acryloxyethanesulfonic acid and 2-methacryloxyethanesulfonic acid, 3-acryloxy- and 3-methacryloxypropanesulfonic acid, vinylbenzenesulfonic acid and their salts;
ethylenically unsaturated phosphonic acids, such as vinylphosphonic acid and dimethyl vinylphosphonate and their salts; and
monoethylenically unsaturated monomers which carry one or two carboxyl groups, for example α,β-ethylenically unsaturated C₃-C₈-mono- and C₄-C₈-dicarboxylic acids, in particular acrylic acid, methacrylic acid, crotonic acid, maleic acid, fumaric acid and itaconic acid.

Preferred acidic monomers M1a are the abovementioned monoethylenically unsaturated monomers having one or two carboxyl groups.

In addition to the monomers M1a, the polymer may also comprise up to <80% by weight of ethylenically unsaturated monomers different from the monomers M1a. These are preferably neutral monoethylenically unsaturated monomers M1b having a limited solubility in water of preferably not more than 30 g/l and in particular not more than 20 g/l at 25° C. and 1 bar. It is thought that, by virtue of hydrophobic interactions, these monomers promote the formation of the active compound/polymer aggregates. Accordingly, the polymers P1 comprise, based on the total weight of monomers M1, preferably up to 10 to 75% by weight, in particular up to 20 to 70% by weight, particularly preferably 30 to 70% by weight and especially 40 to 65% by weight of monomers M1b.

The monomers M1b include in particular monomers of the formula II

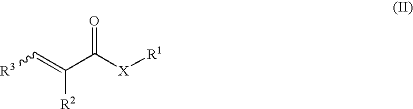

in which
X is oxygen or a group N—R⁴;
R¹ is C₁-C₂₀-alkyl, C₅-C₁₀-cycloalkyl, phenyl, phenyl-C₁-C₄-alkyl or phenoxy-C₁-C₄-alkyl;
R² is hydrogen or C₁-C₄-alkyl;
R³ is hydrogen or C₁-C₄-alkyl; and
R₄ is hydrogen or C₁-C₄-alkyl.

Preferred monomers of the general formula II are those in which R³ in formula II is hydrogen. In formula II R² is preferably hydrogen or methyl. X in the formula II is preferably O, NH, NCH₃ or NC₂H₅ and particularly preferably O.

R¹ in formula II is preferably
C₁-C₂₀-alkyl, in particular C₁-C₁₀-alkyl, such as ethyl, n-propyl, isopropyl, n-butyl, 2-butyl, isobutyl, tert-butyl, 1-pentyl, 2-pentyl, neopentyl, n-hexyl, 2-hexyl, n-octyl, 2-ethylhexyl, 2-propylheptyl, n-decyl, lauryl or stearyl,
C₅-C₁₀-cycloalkyl, such as cyclopentyl, cyclohexyl or methylcyclohexyl,
phenyl-C₁-C₄-alkyl, such as benzyl, 1- or 2-phenylethyl, 1-, 2- or 3-phenylpropyl, or
phenoxy-C₂-C₄-alkyl, such as 2-phenoxyethyl.

R¹ is in particular C₂-C₁₀-alkyl. R¹ is likewise preferably methyl or 2-phenoxyethyl.

Particularly preferred monomers of the formula II are the esters of acrylic acid with C₂-C₁₀-alkanols (═C₂-C₁₀-alkyl acrylates), such as ethyl acrylate, n-butyl acrylate, isobutyl acrylate, tert-butyl acrylate, n-hexyl acrylate, 2-ethylhexyl acrylate and 3-propylheptyl acrylate, the esters of methacrylic acid with C₁-C₁₀-alkanols, such as methyl methacrylate, ethyl methacrylate, n-butyl methacrylate, isobutyl methacrylate, tert-butyl methacrylate and n-hexyl methacrylate. Preferred monomers M1b are furthermore esters of acrylic acid and methacrylic acid with 2-phenoxyethanol, such as 2-phenoxyethyl acrylate. Preferred monomers M1b are furthermore the N—(C₂-C₁₀-alkyl)amides of acrylic acid and methacrylic acid and also the N—(C₁-C₂-alkyl)-N—(C₂-C₁₀-alkyl)amides of acrylic acid and methacrylic acid, for example N-ethylacrylamide, N,N-diethylacrylamide, N-butylacrylamide, N-methyl-N-propylacrylamide, N-(n-hexyl)acrylamide, N-(n-octylacrylamide) and the corresponding methacrylamides. The monomers M1b comprise in particular at least 50% by weight, in particular at least 70% by weight, based on the total amount of monomers M1a, of at least one C₁-C₄-alkyl methacrylate (R¹═C₁-C₄-alkyl, R²═CH₃ and R³═H), and from among these particularly preferably methyl methacrylate and tert-butyl methacrylate.

The monomers M1b furthermore include
vinylaromatic monomers, such as styrene, α-methylstyrene, vinyltoluene, etc.,
olefins having 2 to 20 carbon atoms, preferably α-olefins having 3 to 10 carbon atoms, such as propene, 1-butene, 1-pentene, 1-hexene, 1-octene, diisobutene and 1-decene,
vinyl esters of aliphatic carboxylic acids, such as vinyl acetate, vinyl propionate, vinyl laurate, vinyl nonanoate, vinyl decanoate, vinyl laurate and vinyl stearate,
halogenated olefins, such as vinyl chloride,
C₁₁-C₂₀-alkyl esters of monoethylenically unsaturated monocarboxylic acids having preferably 3 to 6 carbon atoms, for example C₁₁-C₂₀-alkyl acrylates and C₁₁-C₂₀-alkyl methacrylates, such as lauryl acrylate, lauryl methacrylate, isotridecyl acrylate, isotridecyl methacrylate, stearyl acrylate, stearyl methacrylate,
di-C₁-C₂₀-alkyl esters of ethylenically unsaturated dicarboxylic acids having preferably 4 to 8 carbon atoms, for example di-C₁-C₂₀-alkyl esters of fumaric acid and maleic acid, such as dimethyl fumarate, dimethyl maleate, dibutyl fumarate and dibutyl maleate,
glycidyl esters of monoethylenically unsaturated monocarboxylic acids having preferably 3 to 6 carbon atoms, such as glycidyl acrylate and glycidyl methacrylate.

Preferred monomers M1b are the monomers of the formula II and furthermore vinylaromatic monomers, and from among these in particular styrene. Preferred monomers M1b are also mixtures of the abovementioned monomers M1b comprising predominantly, in particular at least 60% by weight and particularly preferably 70% by weight, for example from 60 to 99% by weight or from 70 to 99% by weight, based on the total amount of monomers M1b, of monomers of the formula II or a mixture of the monomers II with styrene and at least one monomer M1b different therefrom.

In addition to the monomers M1a and M1b, the polymers P1 may comprise up to 20% by weight, in particular not more than 10% by weight, based on the total amount of monomers M1, of ethylenically unsaturated monomers M1c different from the monomers M1a and M1b.

The monomers M1c include monoethylenically unsaturated monomers M1c.k which have at least one cationic group. The monomers M1c.k include in particular those having a quaternary ammonium group or a quaternized imino group. Examples of monomers having a quaternized imino group are N-alkylvinylpyridinium salts and N-alkyl-N′-vinylimidazolinium salts, such as N-methyl-N′-vinylimidazolinium chloride or metosulfate. From among the monomers M1c.k, particular preference is given to the monomers of the formula III

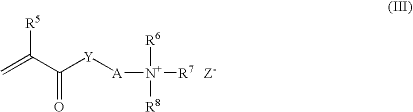

in which
R⁵ is hydrogen or C₁-C₄-alkyl, in particular hydrogen or methyl,
R⁶, R⁷ and R⁸ independently of one another are C₁-C₄-alkyl, in particular methyl, and
Y is oxygen, NH or NR⁹, where R⁹═C₁-C₄-alkyl,
A is C₂-C₈-alkylene, for example 1,2-ethanediyl, 1,2- or 1,3-propanediyl, 1,4-butanediyl or 2-methyl-1,2-propanediyl, which is optionally interrupted by 1, 2 or 3 nonadjacent oxygen atoms, such as in 3-oxapentane-1,5-diyl, and
Z⁻ is an anion equivalent, for example Cl⁻, HSO₄⁻, ½ SO₄²⁻ or CH₃OSO₃⁻ etc.

Examples of such monomers M1c.k are 2-(N,N,N-trimethylammonium)ethyl acrylate chloride, 2-(N,N,N-trimethylammonium)ethyl methacrylate chloride, 2-(N,N,N-trimethylammonium)ethylmethacrylamide chloride, 3-(N,N,N-trimethylammonium)-propyl acrylate chloride, 3-(N,N,N-trimethylammonium)-propyl methacrylate chloride, 3-(N,N,N-trimethylammonium)propylacrylamide chloride, 3-(N,N,N-trimethylammonium)propylmethacrylamide chloride, 2-(N,N,N-trimethylammonium)ethylacrylamide chloride, and the corresponding metosulfates and sulfates.

The proportion of monomers M1c.k in the monomers M1 is advantageously not more than 20% by weight, for example from 0.1 to 20% by weight, in particular from 0.5 to 15% by weight and especially from 1 to 10% by weight. In a preferred embodiment, the polymer P1 comprises no or not more than 0.1% by weight of monomers M1c.k.

The monomers M1c also include monomers M1c.v having two or more nonconjugated ethylenically unsaturated double bonds. The proportion of such monomers M1c.v is generally not more than 2% by weight and in particular not more than 0.5% by weight, based on the total amount of monomer M1. Examples of these are vinyl and allyl esters of monoethylenically unsaturated carboxylic acids, such as allyl acrylate and allyl methacrylate, di- and polyacrylates of di- or polyols, such as ethylene glycol diacrylate, ethylene glycol dimethacrylate, butanediol diacrylate, butanediol dimethacrylate, hexanediol diacrylate, hexanediol dimethacrylate, triethylene glycol diacrylate, triethylene glycol trimethacrylate, tris(hydroxymethyl)ethane triacrylate and tris(hydroxymethyl)ethane trimethacrylate, pentaerythritol triacrylate and pentaerythritol trimethacrylate, furthermore the allyl and methallyl esters of polyfunctional carboxylic acids, such as diallyl maleate, diallyl fumarate, diallyl phthalate. Typical monomers M1c.3 are also compounds such as divinylbenzene, divinylurea, diallylurea, triallyl cyanurate, N,N′-divinyl- and N,N′-diallylimidazolidin-2-one, and also methylenebisacrylamide and methylenebismethacrylamide.

In a particularly preferred embodiment 2a, the polymer P1 comprises, based on the total amount of monomers M1,

from 20 to 80% by weight, in particular from 25 to 60% by weight, of basic monomers M1a, and from 20 to 80% by weight, in particular from 40 to 75% by weight, of monomers M1b.

Preferred monomers M1a in embodiment 2a are vinyl-substituted nitrogen heteroaromatics, especially the abovementioned vinylpyridines, and the monomers of the formula I. Particularly preferred monomers M1a are the monomers of the formula I.

Preferred monomers M1b in embodiment 2a are the monomers of the formula II and furthermore vinylaromatic monomers and from among these in particular styrene. Preferred monomers M1b are also mixtures of the abovementioned monomers M1b comprising predominantly, in particular at least 60% by weight and particularly preferably 70% by weight, for example from 60 to 99% by weight or from 70 to 99% by weight, based on the total amount of monomers M1b, of monomers of the formula II or a mixture of the monomers II with styrene and at least one monomer M1b different therefrom. The monomers M1b comprise in particular exclusively or virtually exclusively (>95% by weight) monomers of the general formula II and especially a mixture of two or more different esters of acrylic acid or of methacrylic acid (R²═H or methyl, R³═H and X═O).

In a preferred embodiment, the monomers M1b are a mixture of a C₁-C₄-alkyl methacrylate, such as methyl methacrylate, with a phenyl-C₁-C₄-alkyl (meth)acrylate or phenoxy-C₁-C₄-alkyl (meth)acrylate, for example with 2-phenoxyethyl methacrylate.

In a further particularly preferred embodiment 3a, the polymer P1 comprises, based on the total amount of monomers M1,

from 20 to 80% by weight, in particular from 25 to 60% by weight, of monomers M1a which carry carboxyl groups and from 20 to 80% by weight, in particular from 40 to 75% by weight, of monomers M1b.

Preferred monomers M1a in embodiment 3a are monoethylenically unsaturated mono- and dicarboxylic acids, especially acrylic acid, methacrylic acid, itaconic acid, maleic acid and fumaric acid.

Preferred monomers M1b in embodiment 3a are monomers of the formula II, C₂-C₁₀-olefins and vinylaromatics, in particular styrene, C₁-C₈-alkyl methacrylates, such as methyl methacrylate, n-butyl methacrylate, tert-butyl methacrylate, n-hexyl methacrylate and 2-ethylhexyl methacrylate.

According to the invention, the polymers P1 carry reactive functional groups R1 which react with the isocyanate groups forming bonds. The mean number of such groups per polymer molecule (functionality) is generally not more than 3, frequently not more than 2 and is, for example, in the range from 0.3 to 3, frequently in the range from 0.5 to 2, or preferably in the range from 0.3 to 1.8, in particular in the range from 0.5 to 1.5 and especially in the range from 0.6 to 1.4. The functional group R1 may be located in the polymer chain and is preferably at the end of the polymer chain.

With a view to the use of the polymer composition according to the invention for formulating active compounds, the hydrophobic polymer P1 preferably has a number-average molecular weight in the range from 500 to 20 000 dalton and in particular in the range from 1500 to 15 000 dalton.

In principle, polymers P1 are known from the prior art, for example from U.S. Pat. No. 5,556,918 and EP-A 742 238. They are generally prepared by free-radical-initiated solution polymerization of the monomers M1 in the presence of an initiator and, if appropriate, a regulator, with the proviso that the initiator, on decomposition, generates a hydroxyl radical (^{.}OH radical) or a fragment which has an OH group and/or the regulator comprises an OH group or an NH₂ group. Suitable initiators are organic hydroperoxides, such as tert-butyl hydroperoxide, tetrahydrofuran hydroperoxide, cumene hydroperoxide or OH-group-bearing azo initiators, such as 2,2′-azobis(2-methyl-N-(2-hydroxyethyl)propionamide). Suitable regulators are aminoalcohols, aminomercaptans, aminophenols and in particular thioalkanols, such as 3-hydroxypropanethiol, 2-hydroxyethyl-3-mercaptopropionic esters and especially 2-hydroxyethanethiol (mercaptoethanol) and mercaptoglycerol, but also aminomercaptans, such as cysteamine (=2-aminoethanethiol). If such a regulator is used, the polymerization can also be carried out in the presence of a conventional initiator, for example a conventional azo initiator or an organic peroxide, such as azobis(isobutyronitrile), di-(tert-butyl) peroxide, didecanoyl peroxide, dibenzoyl peroxide, tert-butyl peracetate or tert-butyl 2-methylperpropionate. If the polymerization is carried out in the presence of one of the regulators mentioned above, the regulator will generally be employed in an amount of from 0.1 to 5% by weight, frequently from 0.2 to 4% by weight and in particular from 0.5 to 3% by weight, based on the total amount of monomers M1. Initiators are generally employed in an amount of from 0.05 to 5% by weight, frequently from 0.1 to 4% by weight and particularly preferably in an amount of from 0.2 to 3% by weight, based on the monomers M1 to be polymerized.

Examples of suitable solvents for the polymerization of the monomers M1 are alkanols, such as methanol, ethanol, n- and isopropanol, aliphatic ketones, such as acetone, methyl ethyl ketone, cyclohexanone, alkyl esters of carboxylic acids, such as methyl acetate, ethyl acetate, methyl propionate, ethyl propionate, n-butyl acetate, alicyclic and cyclic ethers, such as diethyl ether, diisopropyl ether, methyl tert-butyl ether, tetrahydrofuran, aromatic, aliphatic and alicyclic hydrocarbons, such as toluene, xylenes, hexane, cyclohexane, nitriles, such as acetonitrile, and also N-alkyllactams, such as N-methylpyrrolidone, N-ethylpyrrolidone and mixtures of these solvents.

For further details, reference is made in particular to page 3 of EP 742 238 whose disclosure is expressly incorporated herein by way of reference.

According to the invention, the polymers P2 are straight-chain or branched poly-C₂-C₄-alkylene ethers, i.e. polymers which substantially, i.e. to at least 90% by weight, based on the weight of the polymers P2, are constructed of repeat units of the formula IV

A—O (IV)

in which A is a C₂-C₄-alkylene group, such as ethane-1,2-diyl, propane-1,2-diyl, propane-1,3-diyl, butane-1,2-diyl or butane-1,3-diyl. From among the polymers P2, preference is given to those constructed to at least 50% by weight, preferably at least 70% by weight, in particular at least 80% by weight and especially at least 90% by weight of ethylene oxide units, i.e. groups of the formula IV, where A is 1,2-ethanediyl. In addition, the aliphatic polyethers may have structural units derived from C₃-C₄-alkylene oxides.

From among the polymers P2, preference is given in particular to those which, with respect to the functional groups R2, have a functionality F2 in the range from 0.5 to 3 and in particular in the range from 0.6 to 2.5.

The number-average molecular weight of the polymers P2, determined by GPC according to customary methods, is preferably in the range from 500 to 20 000 dalton and in particular in the range from 800 to 15 000 dalton.

Particularly preferred polyethers P2 are those of the formula V

R^{a}—X—(CHR^{b}—CH₂—O)ₚ—H (V)

in which
R^{a} is hydrogen, C₁-C₂₀-alkyl or benzyl,
X is oxygen or NH,
R^{b} is hydrogen or methyl, where at least 50 mol %, in particular at least 70 mol % and preferably at least 90 mol % of the groups R^{b} are hydrogen,
p is an integer whose mean is in the range from 10 to 500, preferably from 20 to 250 and in particular from 25 to 100 (number-average).

Suitable polyethers P2 are known to the person skilled in the art, and most of them are commercially available, for example under the trade names Pluriol® and Pluronic® (polyethers from BASF Aktiengesellschaft).

The total proportion of polymers P1 in the polymer composition according to the invention, i.e. the total amount of reacted and unreacted polymer P1, is preferably from 9 to 90 and in particular from 20 to 68% by weight of the total weight of polymer P1, polymer P2 and compound V.

The total proportion of polyethers P2 in the polymer composition according to the invention, i.e. the total amount of reacted and unreacted polymer P2, is preferably from 9 to 90 and in particular from 30 to 78% by weight of the total weight of polymer P1, polyether P2 and compound V.

The total proportion of compound V in the polymer composition according to the invention, i.e. the total amount of compound V employed, is preferably from 1 to 20 and in particular from 2 to 15% by weight of the total weight of polymer P1, polyether P2 and compound V.

The weight ratio of polymer P1 to polyether P2 in the polymer composition according to the invention, in each case calculated as the total amount of polymers used for the preparation, is preferably in the range from 1:10 to 10:1 and in particular in the range from 1:4 to 2.2:1.

Suitable compounds V having, with respect to the isocyanate groups, a functionality of at least 1.5, in particular from 1.5 to 4.5 and especially from 1.8 to 3.5, comprise aliphatic, cycloaliphatic and aromatic di- and polyisocyanates and also the isocyanurates, allophanates, urethdiones and biurets of aliphatic, cycloaliphatic and aromatic diisocyanates.

The compounds V preferably have, on average, 1.8 to 3.5 isocyanate groups per molecule. Examples of suitable compounds V are aromatic diisocyanates, such as toluene 2,4-diisocyanate, toluene 2,6-diisocyanates, commercially available mixtures of toluene 2,4- and 2,6-diisocyanate (TDI), n-phenylene diisocyanate, 3,3′-diphenyl-4,4′-biphenylene diisocyanate, 4,4′-biphenylene diisocyanate, 4,4′-diphenylmethane diisocyanate, 3,3′-dichloro-4,4′-biphenylene diisocyanate, cumene 2,4-diisocyanate, 1,5-naphthalene diisocyanate, p-xylylene diisocyanate, p-phenylene diisocyanate, 4-methoxy-1,3-phenylene diisocyanate, 4-chloro-1,3-phenylene diisocyanate, 4-ethoxy-1,3-phenylene diisocyanate, 2,4-dimethylene-1,3-phenylene diisocyanate, 5,6-dimethyl-1,3-phenylene diisocyanate, 2,4-diisocyanatodiphenyl ether, aliphatic diisocyanates, such as ethylene diisocyanate, ethylidene diisocyanate, propylene 1,2-diisocyanate, 1,6-hexamethylene diisocyanate, 1,4-tetramethylene diisocyanate, 1,10-decamethylene diisocyanate, and cycloaliphatic diisocyanates, such as isophorone diisocyanate (IPDI), cyclohexylene 1,2-diisocyanate, cyclohexylene 1,4-diisocyanate and bis(4,4′-isocyanatocyclohexyl)methane. From among the diisocyanates, preference is given to those whose isocyanate groups differ in their reactivity, such as toluene 2,4-diisocyanate, toluene 2,6-diisocyanate, mixtures thereof and cis- and trans-isophorone diisocyanate.

In another preferred embodiment of the invention, a biuret or an isocyanurate of an aliphatic or cycloaliphatic diisocyanate compound, for example the cyanurate of tetramethylene diisocyanate or of hexamethylene diisocyanate, is used to prepare the polymer composition according to the invention.

To prepare the polymer composition according to the invention, the hydrophobic polymer P1 and the hydrophilic polyether P2 are reacted successively or simultaneously with the compound V, under reaction conditions where the groups R1 and/or R² react with the isocyanate groups with bond formation.

The reaction can be carried out in the absence or in the presence of small amounts of customary catalysts which promote the formation of urethanes or ureas. Suitable catalysts are, for example, tertiary amines, for example triethylamine, tri-n-propylamine, N-methylpyrrolidine, N-methylpiperidine and diazabicyclooctane (DABCO), organotin compounds, in particular dialkyltin(IV) salts of aliphatic carboxylic acids, such as dibutyltin dilaurate and dibutyltin dioctoate, tin(II) dialkanoates, such as tin dioctoate, tetraalkyl orthotitanates, such as tetrabutyl orthotitanate, and also cesium salts, such as cesium acetate. If desired, the catalyst is employed in an amount of not more than 0.1% by weight, based on the compound V, for example in an amount of from 0.01 to 0.1% by weight, in particular up to 0.05% by weight.

The required reaction temperatures depend, of course, on the reactivity of the functional group R¹ or R² and on the isocyanate compound V and, if employed, on the type and the amount of catalyst used. They are generally in the range from 10 to 120° C. and in particular in the range from 15 to 85° C.

It is self-evident that the reaction of the polymers P1 and P2 with the isocyanate compound V is carried out in the absence of moisture (water content preferably <10 000 ppm and in particular <2000 ppm).

The reaction of P1 and P2 with the compound V can be carried out neat or in an organic solvent which is inert to the isocyanate groups of the compound V. Examples of suitable solvents are aliphatic ketones, such as acetone, methyl ethyl ketone, cyclohexanone, alkyl esters of aliphatic carboxylic acids, such as methyl acetate, ethyl acetate, methyl propionate, ethyl propionate, n-butyl acetate, alicyclic and cyclic ethers, such as diethyl ether, diisopropyl ether, methyl tert-butyl ether, tetrahydrofuran, aromatic, aliphatic and alicyclic hydrocarbons, such as toluene, xylenes, hexane, cyclohexane, nitriles, such as acetonitrile, and also N-alkyllactams, such as N-methylpyrrolidone, N-ethylpyrrolidone and mixtures of these solvents.

The reaction of the polymer P1 and the polymer P2 with the compound V can be carried out successively or simultaneously, i.e. polymers P1 and P2 can be reacted one after the other or both at the same time with the compound V.

If the polymers P1 and P2 are reacted with the compound V one after the other, it is possible both to react initially the polymer P1 with the compound V and then the polyether P2 with the compound V, and vice versa.

If the polymers P1 and P2 are reacted successively with the compound V, the reaction is preferably carried out such that, after the reaction with the first polymer P1 or P2 has ended, at least 10 mol % to 90 mol %, in particular 20 mol % to 80 mol %, of the isocyanate groups in V have reacted with the functional groups R¹ and/or R², and 10 to 90 mol %, in particular 20 to 80 mol %, of the isocyanate groups present are still available. This is followed by the reaction with the second polymer P1 or P2. Accordingly, the first polymer P1 or P2 is preferably employed in an amount such that the molar ratio of reactive groups R¹ and/or R² to the number of isocyanate groups per molecule V is in the range from 0.1:1 to 0.9:1 and in particular in the range from 0.2:1 to 0.8:1. The product obtained in this manner is then reacted with the second polymer, the second polymer P1 or P2 preferably being employed in an amount such that the total amount of reactive groups R1+R2 corresponds at least to the number of isocyanate groups of the compound V. Preferably, the ratio R1+R2 to the total amount of isocyanate groups will not exceed a value of 1.2:1.

If the polymers P1 and P2 are reacted simultaneously with the isocyanate compound V, the polymers P1 and P2 are preferably employed in an amount such that the molar ratio of reactive groups R1+R2 to the isocyanate groups is at least 1:1. Preferably, the ratio R1+R2 to the total amount of isocyanate groups will not exceed a value of 1.2:1.

In the reaction, the isocyanate compound V can be employed as such. However, it is also possible to employ the isocyanate compound V in a form where some of the isocyanate groups are reversibly blocked by a protective group. Many compounds which block (cap or protect) isocyanate groups have been described in the literature (cf., for example, Z. W. Wicks, Prog. Org. Coat. 3 (1975) 73-99 and 9 (1981) 3-28 or Houben-Weyl, Methoden der Organischen Chemie [Methods of Organic Chemistry], Vol. XIV/2, p. 61 ff., Georg Thieme Verlag, Stuttgart 1963). Examples of isocyanate group-blocking agents which may be mentioned are phenols, caprolactam, imidazoles, pyrazoles, pyrazolinones, 1,2,4-triazoles, diketopiperazines, malonic esters and oximes. However, to achieve the successful results according to the invention, it is not necessary to employ isocyanates which are partially blocked in a reversible manner.

In a particularly preferred embodiment of the invention, in a first reaction step, the hydrophobic polymer P1 is prepared in the manner described above by free-radical solvent polymerization, and the reaction with the isocyanate V is carried out in the resulting liquid reaction mixture in the manner described herein, without prior isolation of the polymer P1. The resulting reaction mixture is then reacted with the polymer P2, preferably with a polyether. Alternatively, the desired amount of polyether P2 may be added to the polymer P1 prepared in this manner, followed by reaction with compound V.

To prepare the aqueous active compound formulations, the polymer composition obtained according to the invention can be isolated from the reaction mixture. However, it is also possible to use the reaction mixture as such.

In a preferred embodiment of the invention, the solvent employed for preparing the polymer composition is partially or completely replaced by water, which gives an aqueous dispersion of the polymer composition. This can be achieved, for example, by initially removing the solvent by distillation and then dispersing the residue in water or an aqueous medium. It is also possible to add water to the solution of the polymer composition and to remove the solvent after the addition of the water, or at the same time.

The active compound composition according to the invention can be prepared by different routes. The preparation of the active compound or effect substance composition according to the invention typically comprises the preparation or provision of a homogeneous, nonaqueous mixture, comprising the polymer composition according to the invention and at least one active compound and/or effect substance.

In a first embodiment of the present invention, the aqueous active compound composition is prepared by initially preparing a homogeneous nonaqueous mixture comprising polymer composition and active compound and/or effect substance and then dispersing the resulting mixture in water or an aqueous medium. To prepare the homogeneous nonaqueous mixture, the active compound is generally incorporated into a liquid form of the polymer composition, for example a melt or, preferably, a solution in an organic solvent. If a solvent is used, the solvent is subsequently as substantially as possible and preferably completely removed, giving a solid solution of the active compound in the polymer composition. Solvents suitable for this purpose are, in principle, those capable of dissolving both the active compound and the polymer, for example aliphatic nitrites, such as acetonitrile and propionitrile, N,N-dialkylamides of aliphatic carboxylic acids, such as dimethylformamide and dimethylacetamide, N-alkyllactams, such as N-methylpyrrolidone, the aliphatic and alicyclic ethers mentioned above, for example tetrahydrofuran, halogenated hydrocarbons, such as dichloromethane, dichloroethane, and mixtures of the solvents mentioned above. To prepare the aqueous composition according to the invention, the resulting solid solution of the active compound in the polymer composition is then dispersed by stirring in an aqueous medium. Stirring can be carried out at temperatures in the range of ambient temperature or else at elevated temperature, for example at a temperature in the range from 10 to 80° C. and in particular in the range from 20 to 50° C.

In a second embodiment of the present invention, the aqueous active compound composition is prepared by incorporating the active compound and/or effect substance into an aqueous solution/dispersion of the polymer composition. This is generally achieved by carrying out the incorporation at a temperature above the melting point of the active compound or effect substance and preferably at a temperature where the active compound or effect substance melt has a low viscosity, i.e. a viscosity in the range from 1 to 1000 mPa·s (according to DIN 53019-2 at 25° C.). The incorporation is preferably carried out using strong shear forces, for example in an Ultraturrax.

In a third embodiment of the invention, the aqueous active compound composition is prepared by a process which comprises the following steps a to c:
a) preparing a solution of active compound and/or effect substance and, if appropriate, polymer composition in an organic solvent having a boiling point below that of water and
b) mixing the solution of the active compound and/or effect substance with water or an aqueous solution comprising the amphiphilic copolymer and
c) removing the solvent.

Alternatively, this may be carried out in a manner where the solution of the active compound comprises the polymer composition, and this solution is mixed with water, or where the solution of the active compound comprises only part of the polymer composition or no polymer composition, and this solution is mixed with an aqueous solution or dispersion of the polymer composition. Mixing may be carried out in suitable stirring vessels, it being possible either to initially charge water or the aqueous solution of the polymer composition and to add the solution of the active compound or effect substance, or, alternatively, to initially charge the solution of the active compound or effect substance and to add the water or the aqueous solution of the polymer composition. The organic solvent is then removed, for example by distillation, where, if appropriate, water is added.

In a preferred variant of this embodiment, the active compound solution and the water or the aqueous solution of the polymer composition are/is continuously added to a mixing zone, and the mixture, from which the solvent is then removed, is continuously removed from the mixing zone. The mixing zone can be designed as desired. In principle, all apparatus which allows continuous mixing of liquid streams is suitable for this purpose. Such apparatus is known, for example, from Continuous Mixing of Fluids (J.-H. Henzier) in Ullmann's Encyclopedia 5th ed. on CD-Rom, Wiley-VCH. The mixing zone may be designed as a static or dynamic mixer or mixed forms thereof. Suitable mixing zones are in particular also jet mixers or comparable mixers having nozzles. In a preferred embodiment, the mixing zone is the apparatus described in “Handbook of Industrial Crystallization” (A. S. Myerson, 1993 Butterworth-Heinemann, page 139, ISBN 0-7506-9155-7) or a comparable apparatus.

The volume ratio of active compound solution to water or aqueous solution of the polymer composition according to the invention can be varied over a wide range and is preferably in the range 10:1 to 1:20 and in particular in the range from 5:1 to 1:10.

The nature of the solvent should be such that the polymer composition according to the invention and the active compound are dissolved in the desired ratios. By standard experiments, the person skilled in the art is able to determine suitable solvents. Examples of suitable solvents are C₂-C₄-alkanols, such as ethanol, n-propanol, n-butanol, isobutanol, the aliphatic and alicyclic ethers mentioned above, such as diethyl ether, diisopropyl ether, methyl tert-butyl ether, dioxane, tetrahydrofuran, ketones such as acetone, methyl ethyl ketone, lactones, such as gamma-butyrolactone, carbonates, such as diethyl carbonate, ethylene carbonate, propylene carbonate, lactams, such as pyrrolidone, N-methylpyrrolidone, N-ethylpyrrolidone, caprolactam, amides of aliphatic carboxylic acids, such as acetamide, N,N-dimethylacetamide, N,N-dimethylformamide, nitriles, such as acetonitrile and propionitrile, and the like.

In a further embodiment of the present invention, a nonaqueous active compound composition is prepared by preparing a homogeneous nonaqueous mixture of a polymer composition according to the invention and active compound and/or effect substance. Unless this composition comprises liquid components, it is generally solid. With respect to the preparation of such compositions, what was said above in connection with the first embodiment for preparing a homogeneous nonaqueous mixture comprising an amphiphilic polymer composition and active compound and/or effect substance applies analogously; however, at this point, if appropriate, desired additives and auxiliaries may be incorporated in a manner known per se into the composition. This variant is particularly suitable for preparing solvent-free nonaqueous solid compositions, but also for preparing solvent-comprising formulations.

It has been found to be advantageous if the weight ratio of active compound and/or effect substance to the polymer composition in the aqueous active compound compositions according to the invention is in the range from 1:10 to 3:1 and in particular in the range from 1:5 to 2:1.

The content of active compound and/or effect substance can be varied over wide ranges. In particular, using the polymer compositions, it is possible to prepare what are known as active compound concentrates which comprise the active compound in an amount of at least 5% by weight, for example in an amount of from 5 to 50% by weight and in particular in an amount of from 5 to 20% by weight, based on the total weight of the composition.

Advantageously, the compositions according to the invention, in particular the aqueous active compound compositions can be formulated as solvent-free or low-solvent compositions, i.e. the proportion of volatile components in the aqueous active compound composition is frequently not more than 10% by weight, in particular not more than 5% by weight and especially not more than 1% by weight, based on the total weight of the composition. Here, volatile components are those whose boiling point at atmospheric pressure is below 200° C.

A large number of different active compounds and effect substances can be formulated in the aqueous compositions according to the invention. The polymer compositions according to the invention are particularly suitable for formulations of organic active compounds, in particular low-molecular-weight active compounds having a molecular weight of less than 500 dalton. A particular embodiment of the invention relates to the formulation of active compounds for crop protection, i.e. of herbicides, fungicides, nematicides, acaricides, insecticides and also active compounds which regulate plant growth.

Examples of fungicidally active compounds which can be formulated as aqueous active compound composition according to the invention include the following organic compounds:
acylalanines, such as benalaxyl, metalaxyl, ofurace, oxadixyl;
amine derivatives, such as aldimorph, dodine, dodemorph, fenpropimorph, fenpropidin, guazatine, iminoctadine, spiroxamine, tridemorph;
anilinopyrimidines, such as pyrimethanil, mepanipyrim or cyprodinil;
antibiotics, such as cycloheximide, griseofulvin, kasugamycin, natamycin, polyoxin and streptomycin and validamycin A;
azoles, such as bitertanol, bromuconazole, cyazofamid, cyproconazole, difenoconazole, dinitroconazole, epoxiconazole, etridazole, fenbuconazole, fluquinconazole, flusilazole, flutriafol, fuberidazole, hexaconazole, hymexazole, imizalil, ipconazole, imibenconazole, metconazole, myclobutanil, penconazole, perfuazorate, propiconazole, prochloraz, prothioconazole, simeconazole, tebuconazole, tetraconazole, thiabendazole, triadimefon, triadimenol, triflumizole, triticonazole and 2-butoxy-6-iodo-3-propylchromen-4-one, N,N-dimethyl-3-(3-bromo-6-fluoro-2-methylindole-1-sulfonyl)-[1,2,4]triazole-1-sulfonamide;
2-methoxybenzophenones as described in EP-A 897 904 by the formula I, for example metrafenone;
dicarboximides, such as iprodione, myclozolin, procymidone, vinclozolin;
dithiocarbamates, such as ferbam, nabam, maneb, mancozeb, metam, metiram, propineb, polycarbamate, thiram, ziram, zineb;
heterocyclic compounds, such as anilazine, benomyl, boscalid, carbendazim, carboxin, oxycarboxin, cyazofamid, dazomet, dithianon, ethirimol, dimethirimol, famoxadone, fenamidone, fenarimol, fuberidazole, flutolanil, furametpyr, isoprothiolane, mepronil, nuarimol, octhilinone, picobenzamid, probenazole, proquinazid, pyrifenox, pyroquilon, quinoxyfen, silthiofam, thiabendazole, thifluzamide, thiophanate-methyl, tiadinil, tricyclazole, triforine, 3-[5-(4-chlorophenyl)-2,3-dimethylisoxazolidin-3-yl]pyridine, and bupirimate;
nitrophenyl derivatives, such as binapacryl, dinocap, dinobuton, nitrophthal-isopropyl;
phenylpyrroles, such as fenpiclonil and also fludioxonil;
fungicides not belonging to any of the other classes, such as acibenzolar-5-methyl, benthiavalicarb, carpropamid, chlorothalonil, cyflufenamid, cymoxanil, diclomezine, diclocymet, diethofencarb, edifenphos, ethaboxam, fenhexamid, fentin-acetate, fenoxanil, ferimzone, fluazinam, fosetyl, fosetyl-aluminum, iprovalicarb, hexachlorobenzol, metrafenone, pencycuron, propamocarb, phthalide, toloclofos-methyl, quintozene, zoxamide, isoprothiolane, fluopicolide (picobenzamid); carpropamid, mandipropamid, N-(2-{4-[3-(4-chlorophenyl)prop-2-ynyloxy]-3-methoxyphenyl}ethyl)-2-methanesulfonylamino-3-methylbutyramide, N-(2-{4-[3-(4-chlorophenyl)prop-2-ynyloxy]-3-methoxyphenyl}ethyl)-2-ethanesulfonylamino-3-methylbutyramide; furametpyr, thifluzamide, penthiopyrad, fenhexamid, N-(2-cyanophenyl)-3,4-dichloroisothiazole-5-carboxamide, flubenthiavalicarb, methyl 3-(4-chlorophenyl)-3-(2-isopropoxycarbonylamino-3-methylbutyrylamino)propionate, methyl {2-chloro-5-[1-(6-methylpyridin-2-ylmethoxyimino)ethyl]benzyl}-carbamate, methyl {2-chloro-5-[1-(3-methylbenzyloxyimino)ethyl]benzyl}-carbamate, flusulfamide, amides of the formula

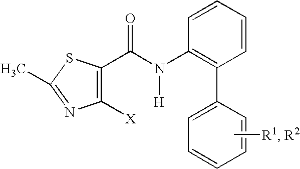

in which
X is CHF₂ or CH₃; and
R¹, R² independently of one another are halogen, methyl or halomethyl, for example CF₃;
strobilurins as described in WO 03/075663 by the general formula I, for example: azoxystrobin, dimoxystrobin, fluoxastrobin, kresoxim-methyl, metominostrobin, orysastrobin, picoxystrobin, pyraclostrobin and trifloxystrobin;
sulfenic acid derivatives, such as captafol, captan, dichlorfluanid, folpet, tolylfluanid;
cinnamides and analogs thereof, such as dimethomorph, flumetover, flumorph;
6-aryl[1,2,4]triazolo[1,5-a]pyrimidines as described, for example, in WO 98/46608, WO 99/41255 or WO 03/004465 in each case by the formula I, for example 5-chloro-7-(4-methylpiperidin-1-yl)-6-(2,4,6-trifluorophenyl)[1,2,4]triazolo[1,5-a]pyrimidine;
amide fungicides, such as cyclofenamid, and also (Z)-N—[α-(cyclopropylmethoxyimino)-2,3-difluoro-6-(difluoromethoxy)benzyl]-2-phenylacetamide.

Examples of herbicides which may be formulated as aqueous active compound compositions according to the invention include:
1,3,4-thiadiazoles, such as buthidazole and cyprazole;
amides, such as allidochlor, benzoylprop-ethyl, bromobutide, chlorthiamid, dimepiperate, dimethenamid, diphenamid, etobenzanid, flamprop-methyl, fosamine, isoxaben, metazachlor, monalide, naptalam, pronamide, propanil;
aminophosphoric acids, such as bilanafos, buminafos, glufosinate-ammonium, glyphosate, sulfosate;
aminotriazoles, such as amitrole, anilides, such as anilofos, mefenacet;
anilides, such as anilofos, mefenacet;
aryloxyalkanoic acids, such as 2,4-D, 2,4-DB, clomeprop, dichlorprop, dichlorprop-P, fenoprop, fluoroxypyr, MCPA, MCPB, mecoprop, mecoprop-P, napropamide, napropanilide, triclopyr;
benzoic acids, such as chloramben, dicamba;
benzothiadiazinones, such as bentazone;
bleachers, such as clomazone, diflufenican, fluorochloridone, flupoxam, fluridone, pyrazolate, sulcotrione;
carbamates, such as carbetamide, chlorbufam, chlorpropham, desmedipham, phenmedipham, vernolate;
quinolinic acids, such as quinclorac, quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin,
dinitrophenols, such as bromofenoxim, dinoseb, dinoseb-acetate, dinoterb, DNOC, minoterb-acetate;
diphenyl ethers, such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen, oxyfluorfen;
dipyridyls, such as cyperquat, difenzoquat-methyl sulfate, diquat, paraquatdichloride;
imidazoles, such as isocarbamid;
imidazolinones, such as imazamethapyr, imazapyr, imazaquin, imazethabenzmethyl, imazethapyr, imazapic, imazamox;
oxadiazoles, such as methazole, oxadiargyl, oxadiazon;
oxiranes, such as tridiphane;
phenols, such as bromoxynil, ioxynil;
phenoxyphenoxypropionic acid esters, such as clodinafop, cyhalofop-butyl, diclofop-methyl, fenoxaprop-ethyl, fenoxaprop-p-ethyl, fenthiaprop-ethyl, fluazifop-butyl, fluazifop-p-butyl, haloxyfop-ethoxyethyl, haloxyfop-methyl, haloxyfop-p-methyl, isoxapyrifop, propaquizafop, quizalofop-ethyl, quizalofop-p-ethyl, quizalofop-tefuryl;
phenylacetic acids, such as chlorfenac;
phenylpropionic acids, such as chlorophenprop-methyl;
ppi-active compounds, such as benzofenap, flumiclorac-pentyl, flumioxazin, flumipropyn, flupropacil, pyrazoxyfen, sulfentrazone, thidiazimin;
pyrazoles, such as nipyraclofen;
pyridazines, such as chloridazon, maleic hydrazide, norflurazon, pyridate;
pyridinecarboxylic acids, such as clopyralid, dithiopyr, picloram, thiazopyr;
pyrimidyl ethers, such as pyrithiobac-acid, pyrithiobac-sodium, KIH-2023, KIH-6127;
sulfonamides, such as flumetsulam, metosulam;
triazolecarboxamides, such as triazofenamide;
uracils, such as bromacil, lenacil, terbacil;
furthermore benazolin, benfuresate, bensulide, benzofluor, bentazon, butamifos, cafenstrole, chlorthal-dimethyl, cinmethylin, dichlobenil, endothall, fluorbentranil, mefluidide, perfluidone, piperophos, topramezone and prohexadione-calcium;
sulfonylureas, such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron;
crop protection agents of the cyclohexenone type, such as alloxydim, clethodim, cloproxydim, cycloxydim, sethoxydim and tralkoxydim. Very particularly preferred herbicidally active compounds of the cyclohexenone type are: tepraloxydim (cf. AGROW, No. 243, 11.3.95, page 21, caloxydim) and 2-(1-[2-{4-chlorophenoxy}propyloxyimino]butyl)-3-hydroxy-5-(2H-tetrahydrothio-pyran-3-yl)-2-cyclohexen-1-one, and a herbicidally active compound of the sulfonylurea type is: N-(((4-methoxy-6-[trifluoromethyl]-1,3,5-triazin-2-yl)amino)carbonyl)-2-(trifluoromethyl)benzenesulfonamide.

Examples of insecticides which can be formulated as aqueous active compound composition according to the invention include:
organo(thio)phosphates, such as acephate, azamethiphos, azinphos-methyl, chlorpyrifos, chlorpyrifos-methyl, chlorfenvinphos, diazinon, dichlorphos, dimethylvinphos, dioxabenzofos, dicrotophos, dimethoate, disulfoton, ethion, EPN, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, primiphos-ethyl, pyraclofos, pyridaphenthion, sulprophos, triazophos, trichlorfon, tetrachlorvinphos, vamidothion
carbamates, such as alanycarb, benfuracarb, bendiocarb, carbaryl, carbofuran, carbosulfan, fenoxycarb, furathiocarb, indoxacarb, methiocarb, methomyl, oxamyl, pirimicarb, propoxur, thiodicarb, triazamate;
pyrethroids, such as allethrin, bifenthrin, cyfluthrin, cycloprothrin, cypermethrin, cyphenothrin, deltamethrin, esfenvalerate, ethofenprox, fenpropathrin, fenvalerate, cyhalothrin, imoprothrin, lambda-cyhalothrin, permethrin, prallethrin, pyrethrin I, pyrethrin II, silafluofen, tau-fluvalinate, tefluthrin, tralomethrin, transfluthrin, alpha-cypermethrin, zeta-cypermethrin, permethrin;
arthropod growth regulators: a) chitin synthesis inhibitors, for example benzoylureas, such as chlorfluazuron, cyromazine, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists, such as halofenozide, methoxyfenozide, tebufenozide; c) juvenoids, such as pyriproxyfen, methoprene, fenoxycarb; d) lipid biosynthesis inhibitors, such as spirodiclofen;
neonicotinoids, such as flonicamid, clothianidin, dinotefuran, imidacloprid, thiamethoxam, nitenpyram, nithiazine, acetamiprid, thiacloprid;
further insecticides which do not belong to the above classes, such as abamectin, acequinocyl, acetamiprid, amitraz, azadirachtin, bensultap, bifenazate, cartap, chlorfenapyr, chlordimeform, cyromazine, diafenthiuron, dinetofuran, diofenolan, emamectin, endosulfan, ethiprole, fenazaquin, fipronil, formetanate, formetanate hydrochloride, gamma-HCH, hydramethylnon, imidacloprid, indoxacarb, isoprocarb, metolcarb, pyridaben, pymetrozine, spinosad, tebufenpyrad, thiamethoxam, thiocyclam, pyridalyl, flonicamid, fluacypyrim, milbemectin, spiromesifen, flupyrazofos, NC 512, tolfenpyrad, flubendiamide, bistrifluoron, benclothiaz, pyrafluprole, pyriprole, amidoflumet, flufenerim, cyflumetofen, acequinocyl, lepimectin, profluthrin, dimefluthrin, amidrazone, metaflumizone, N—R′-2,2-dihalo-1-R″-cyclopropanecarboxamide-2-(2,6-dichloro-α,α,α-trifluoro-p-tolyl)hydrazone, N—R′-2,2-di(R′″)propionamide-2-(2,6-dichloro-α,α,α-trifluoro-p-tolyl)hydrazone, where halo is chlorine or bromine, R′ is methyl or ethyl, R″ is hydrogen or methyl and R′″ is methyl or ethyl, XMC and xylylcarb, and also compounds of the formulae below

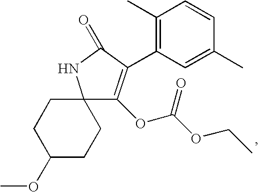

aminoisothiazoles of the formula

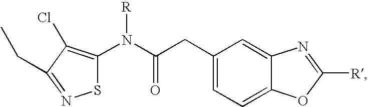

in which
R═—CH₂O—CH₃ or H and
R′═—CF₂CF₂CF₃;
anthranilamides of the formula

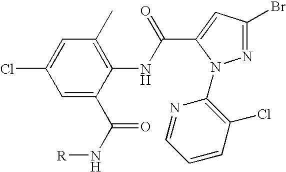

in which R is C₁-C₄-alkyl, such as methyl, ethyl, isopropyl or n-butyl,
and the compound of the formula below

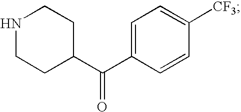

N-phenylsemicarbazones as described in EP-A 462 456 by the formula I, in particular compounds of the formula V

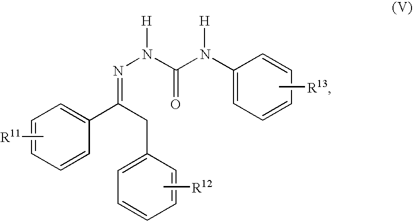

in which R¹¹ and R¹² independently of one another are hydrogen, halogen, CN, C₁-C₄-alkyl, C₁-C₄-alkoxy, C₁-C₄-haloalkyl or C₁-C₄-haloalkoxy and R¹³ is C₁-C₄-alkoxy, C₁-C₄-haloalkyl or C₁-C₄-haloalkoxy, for example compound IV in which R¹¹ is 3-CF₃ and R¹² is 4-CN and R¹³ is 4-OCF₃ (metaflumizone).

Useful growth regulators are, for example, chlormequat-chloride, mepiquat-chloride, prohexadione-calcium or the group of the gibberellins. These include, for example, the gibberellins GA₁, GA₃, GA₄, GA₅ and GA₇, etc., and the corresponding exo-16,17-dihydrogibberellins, and also derivatives thereof, for example the esters with C₁-C₄-carboxylic acids. Preference according to the invention is given to exo-16,17-dihydro-GA₅ 13-acetate, furthermore 1-naphthylacetamide, 1-naphthylacetic acid, 2-naphthyloxyacetic acid, 3-CPA, 4-CPA, ancymidol, anthraquinone, BAP, butifos; tribufos, butralin, chlorflurenol, clofencet, cyclanilide, daminozide, dicamba, dikegulac sodium, dimethipin, chlorfenethol, etacelasil, ethephon, ethychlozate, fenoprop, 2,4,5-TP, fluoridamid, flurprimidol, flutriafol, guazatine, imazalil, indolylbutyric acid, indolylacetic acid, karetazan, kinetin, lactidichlor-ethyl, maleic hydrazide, mefluidide, naptalam, paclobutrazole, quinmerac, sintofen, tetcyclacis, thidiazuron, triiodobenzoic acid, triapenthenol, triazethan, tribufos, trinexapac-ethyl and uniconazole.

A preferred embodiment of the invention relates to the use of the polymer compositions according to the invention for preparing active compound compositions, in particular aqueous active compound compositions of fungicides, in particular strobilurins, azoles and 6-aryltriazolo[1,5a]pyrimidines as described, for example, in WO 98/46608, WO 99/41255 or WO 03/004465, in each case by the formula I, in particular for active compounds of the formula VI,

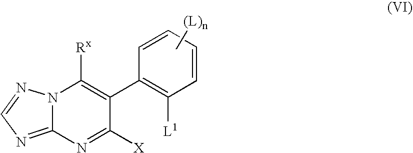

in which
R^{x} is a group NR¹⁴R¹⁵ or linear or branched C₁-C₈-alkyl which is optionally substituted by halogen, OH, C₁-C₄-alkoxy, phenyl or C₃-C₆-cycloalkyl, is C₂-C₆-alkenyl, C₃-C₆-cycloalkyl, C₃-C₆-cycloalkenyl, phenyl or naphthyl, where the 4 last-mentioned radicals may have 1, 2, 3 or 4 substituents selected from the group consisting of halogen, OH, C₁-C₄-alkyl, C₁-C₄-haloalkoxy, C₁-C₄-alkoxy and C₁-C₄-haloalkyl;
R¹⁴, R¹⁵ independently of one another are hydrogen, C₁-C₈-alkyl, C₁-C₈-haloalkyl, C₃-C₁₀-cycloalkyl, C₃-C₆-halocycloalkyl, C₂-C₈-alkenyl, C₄-C₁₀-alkadienyl, C₂-C₈-haloalkenyl, C₃-C₆-cycloalkenyl, C₂-C₈-halocycloalkenyl, C₂-C₈-alkynyl, C₂-C₈-haloalkynyl or C₃-C₆-cycloalkynyl,
   R¹⁴ and R¹⁵ together with the nitrogen atom to which they are attached are five- to eight-membered heterocyclyl which is attached via N and which may contain one, two or three further heteroatoms from the group consisting of O, N and S as ring members and/or may carry one or more substituents from the group consisting of halogen, C₁-C₆-alkyl, C₁-C₆-haloalkyl, C₂-C₆-alkenyl, C₂-C₆-haloalkenyl, C₁-C₆-alkoxy, C₁-C₆-haloalkoxy, C₃-C₆-alkenyloxy, C₃-C₆-haloalkenyloxy, (exo)-C₁-C₆-alkylene and oxy-C₁-C₃-alkyleneoxy;
L is selected from the group consisting of halogen, cyano, C₁-C₆-alkyl, C₁-C₄-haloalkyl, C₁-C₆-alkoxy, C₁-C₄-haloalkoxy and C₁-C₆-alkoxycarbonyl;
L¹ is halogen, C₁-C₆-alkyl or C₁-C₆-haloalkyl and in particular fluorine or chlorine;
X is halogen, C₁-C₄-alkyl, cyano, C₁-C₄-alkoxy or C₁-C₄-haloalkyl and preferably halogen or methyl and in particular chlorine.

Examples of compounds of the formula VI are
5-chloro-7-(4-methylpiperidin-1-yl)-6-(2,4,6-trifluorophenyl)-[1,2,4]triazolo[1,5-a]-pyrimidine,
5-chloro-7-(4-methylpiperazin-1-yl)-6-(2,4,6-trifluorophenyl)-[1,2,4]triazolo[1,5-a]-pyrimidine,
5-chloro-7-(morpholin-1-yl)-6-(2,4,6-trifluorophenyl)-[1,2,4]triazolo[1,5-a]pyrimidine,
5-chloro-7-(piperidin-1-yl)-6-(2,4,6-trifluorophenyl)-[1,2,4]triazolo[1,5-a]pyrimidine,
5-chloro-7-(morpholin-1-yl)-6-(2,4,6-trifluorophenyl)-[1,2,4]triazolo[1,5-a]pyrimidine,
5-chloro-7-(isopropylamino)-6-(2,4,6-trifluorophenyl)-[1,2,4]triazolo[1,5-a]pyrimidine,
5-chloro-7-(cyclopentylamino)-6-(2,4,6-trifluorophenyl)-[1,2,4]triazolo[1,5-a]pyrimidine,
5-chloro-7-(2,2,2-trifluoroethylamino)-6-(2,4,6-trifluorophenyl)-[1,2,4]triazolo[1,5-a]-pyrimidine,
5-chloro-7-(1,1,1-trifluoropropan-2-ylamino)-6-(2,4,6-trifluorophenyl)-[1,2,4]triazolo-[1,5-a]pyrimidine,
5-chloro-7-(3,3-dimethylbutan-2-ylamino)-6-(2,4,6-trifluorophenyl)-[1,2,4]triazolo[1,5-a]-pyrimidine,
5-chloro-7-(cyclohexylmethyl)-6-(2,4,6-trifluorophenyl)-[1,2,4]triazolo[1,5-a]pyrimidine,
5-chloro-7-(cyclohexyl)-6-(2,4,6-trifluorophenyl)-[1,2,4]triazolo[1,5-a]pyrimidine,
5-chloro-7-(2-methylbutan-3-yl)-6-(2,4,6-trifluorophenyl)-[1,2,4]triazolo[1,5-a]pyrimidine,
5-chloro-7-(3-methylpropan-1-yl)-6-(2,4,6-trifluorophenyl)-[1,2,4]triazolo[1,5-a]-pyrimidine,
5-chloro-7-(4-methylcyclohexan-1-yl)-6-(2,4,6-trifluorophenyl)-[1,2,4]triazolo[1,5-a]-pyrimidine,
5-chloro-7-(hexan-3-yl)-6-(2,4,6-trifluorophenyl)-[1,2,4]triazolo[1,5-a]pyrimidine,
5-chloro-7-(2-methylbutan-1-yl)-6-(2,4,6-trifluorophenyl)-[1,2,4]triazolo[1,5-a]pyrimidine,
5-chloro-7-(3-methylbutan-1-yl)-6-(2,4,6-trifluorophenyl)-[1,2,4]triazolo[1,5-a]pyrimidine,
5-chloro-7-(1-methylpropan-1-yl)-6-(2,4,6-trifluorophenyl)-[1,2,4]triazolo[1,5-a]-pyrimidine,
5-methyl-7-(4-methylpiperidin-1-yl)-6-(2,4,6-trifluorophenyl)-[1,2,4]triazolo[1,5-a]-pyrimidine,
5-methyl-7-(4-methylpiperazin-1-yl)-6-(2,4,6-trifluorophenyl)-[1,2,4]triazolo[1,5-a]-pyrimidine,
5-methyl-7-(morpholin-1-yl)-6-(2,4,6-trifluorophenyl)-[1,2,4]triazolo[1,5-a]pyrimidine,
5-methyl-7-(piperidin-1-yl)-6-(2,4,6-trifluorophenyl)-[1,2,4]triazolo[1,5-a]pyrimidine,
5-methyl-7-(morpholin-1-yl)-6-(2,4,6-trifluorophenyl)-[1,2,4]triazolo[1,5-a]pyrimidine,
5-methyl-7-(isopropylamino)-6-(2,4,6-trifluorophenyl)-[1,2,4]triazolo[1,5-a]pyrimidine,
5-methyl-7-(cyclopentylamino)-6-(2,4,6-trifluorophenyl)-[1,2,4]triazolo[1,5-a]pyrimidine,
5-methyl-7-(2,2,2-trifluoroethylamino)-6-(2,4,6-trifluorophenyl)-[1,2,4]triazolo[1,5-a]-pyrimidine,
5-methyl-7-(1,1,1-trifluoropropan-2-ylamino)-6-(2,4,6-trifluorophenyl)-[1,2,4]triazolo-[1,5-a]pyrimidine,
5-methyl-7-(3,3-dimethylbutan-2-ylamino)-6-(2,4,6-trifluorophenyl)-[1,2,4]triazolo[1,5-a]-pyrimidine,
5-methyl-7-(cyclohexylmethyl)-6-(2,4,6-trifluorophenyl)-[1,2,4]triazolo[1,5-a]pyrimidine,
5-methyl-7-(cyclohexyl)-6-(2,4,6-trifluorophenyl)-[1,2,4]triazolo[1,5-a]pyrimidine,
5-methyl-7-(2-methylbutan-3-yl)-6-(2,4,6-trifluorophenyl)-[1,2,4]triazolo[1,5-a]-pyrimidine,
5-methyl-7-(3-methylpropan-1-yl)-6-(2,4,6-trifluorophenyl)-[1,2,4]triazolo[1,5-a]-pyrimidine,
5-methyl-7-(4-methylcyclohexan-1-yl)-6-(2,4,6-trifluorophenyl)-[1,2,4]triazolo[1,5-a]-pyrimidine,
5-methyl-7-(hexan-3-yl)-6-(2,4,6-trifluorophenyl)-[1,2,4]triazolo[1,5-a]pyrimidine,
5-methyl-7-(2-methylbutan-1-yl)-6-(2,4,6-trifluorophenyl)-[1,2,4]triazolo[1,5-a]-pyrimidine,
5-methyl-7-(3-methylbutan-1-yl)-6-(2,4,6-trifluorophenyl)-[1,2,4]triazolo[1,5-a]pyrimidine and 5-methyl-7-(1-methylpropan-1-yl)-6-(2,4,6-trifluorophenyl)-[1,2,4]triazolo[1,5-a]-pyrimidine.

A preferred embodiment of the invention accordingly also relates to the use of the polymer compositions according to the invention for stabilizing or solubilizing fungicides, in particular strobilurins, azoles and 6-aryltriazolo[1,5a]pyrimidines, as described, for example, in WO 98/46608, WO 99/41255 or WO 03/004465, in each case by the general formula I, in particular for active compounds of the general formula VI, in aqueous phase.

A further preferred embodiment of the invention relates to the use of the polymer compositions according to the invention for preparing active compound compositions, in particular for preparing aqueous active compound compositions of insecticides, in particular of arylpyrroles, such as chlorfenapyr, of pyrethroids, such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, alpha-cypermethrin, zeta-cypermethrin and permethrin, of neonicotinoids and of semicarbazones of the formula V.

A preferred embodiment of the invention accordingly also relates to the use of the polymer compositions according to the invention for stabilizing or solubilizing insecticides, in particular arylpyrroles, pyrethroids, neonicotinoids and semicarbazones of the general formula V, in aqueous phase.

The polymer compositions according to the invention are furthermore suitable for preparing active compound compositions, in particular aqueous active compound compositions of pharmaceutically active compounds and prodrugs. These include benzodiazepines, antihypertensives, vitamins, cytostatics—especially taxol, anesthetics, neuroleptics, antidepressants, antibiotics, antimycotics, fungicides, chemotherapeutics, urologicals, platelet aggregation inhibitors, sulfonamides, spasmolytics, hormones, immunoglobulins, sera, thyroid therapeutics, psychopharmaceuticals, anti-Parkinson agents and other antihyperkinetics, opthalmologicals, neuropathy products, calcium metabolism regulators, muscle relaxants, anesthetics, lipid-lowering agents, hepatotherapeutics, coronary agents, cardiac agents, immunotherapeutics, regulatory peptides and their inhibitors, hypnotics, sedatives, gynecologicals, anti-gout agents, fibrinolytics, enzyme products and transport proteins, enzyme inhibitors, emetics, blood flow stimulators, diuretics, diagnostic aids, corticoids, cholinergics, bilary therapeutics, anti-asthmatics, broncho-spasmolytics, beta receptor blockers, calcium antagonists, ACE inhibitors, anti-arteriosclerotics, anti-inflammatory agents, anticoagulants, antihypotensives, antihypo-glycemics, antihypertensives, antifibrinolytics, anti-epileptics, anti-emetics, antidotes, antidiabetics, anti-arrhythmics, anti-anemics, anti-allergics, anthelmintics, analgesics, analeptics, aldosterone antagonists, and slimming products. Examples of suitable pharmaceutically active compounds are in particular the active compounds mentioned in paragraphs 0105 to 0131 of US 2003/0157170.

The polymer compositions according to the invention are furthermore suitable for preparing preparations, in particular aqueous preparations of cosmetically active compounds, in particular of cosmetic oils and fats, such as peanut oil, jojoba oil, coconut oil, almond oil, olive oil, palm oil, castor oil, soybean oil or wheat germ oil, essential oils, such as dwarf pine oil, lavender oil, rosemary oil, fir needle oil, pine needle oil, eucalyptus oil, peppermint oil, sage oil, bergamot oil, turpentine oil, melissa oil, sage oil, juniper berry oil, lemon oil, anise oil, cardamom oil, peppermint oil, camphor oil, etc., or mixtures of these oils.

Moreover, the polymer compositions according to the invention are suitable for preparing preparations, in particular aqueous preparations of food additives, such as water-insoluble vitamins and provitamins, such as vitamin A, vitamin A acetate, vitamin D, vitamin E, tocopherol derivatives, such as tocopherol acetate, and vitamin K.

Accordingly, the polymer compositions according to the invention are also suitable for stabilizing the abovementioned active compounds in aqueous phase.

Examples of effect substances which can be formulated as aqueous active compound compositions according to the invention are:

Dyes: for example the dyes described in DE-A 102 45 209 and the compounds which, according to the Color Index, are referred to as disperse dyes and solvent dyes and which are also called dispersion dyes. A compilation of suitable dispersion dyes can be found, for example, in Ullmanns Enzyklopädie der technischen Chemie [Ullmann's Encyclopedia of Industrial Chemistry], 4th edition, Vol. 10, pp. 155-165 (see also Vol. 7, p. 585ff.—anthraquinone dyes; Vol. 8, p. 244ff.—azo dyes; Vol. 9, p. 313ff.—quinophthalone dyes). This literature reference and the compounds mentioned therein are expressly incorporated herein by way of reference. Dispersion dyes and solvent dyes which are suitable according to the invention include very different classes of dyes with different chromophores, for example anthraquinone dyes, monoazo and diazo dyes, quinophthalones, methyne and azamethyne dyes, naphthalimide dyes, naphthaquinone dyes and nitro dyes. Examples of dispersion dyes which are suitable according to the invention are the dispersion dyes of the following Color Index list: C. I. Disperse Yellow 1-228, C. I. Disperse Orange 1-148, C. I. Disperse Red 1-349, C. I. Disperse Violet 1-97, C. I. Disperse Blue 1-349, C. I. Disperse Green 1-9, C. I. Disperse Brown 1-21, C. I. Disperse Black 1-36. Examples of solvent dyes which are suitable according to the invention are the compounds of the following Color Index list: C. I. Solvent Yellow 2-191, C. I. Solvent Orange 1-113, C. I. Solvent Red 1-248, C. I. Solvent Violet 2-61, C. I. Solvent Blue 2-143, C. I. Solvent Green 1-35, C. I. Solvent Brown 1-63, C. I. Solvent Black 3-50. Other dyes which are suitable according to the invention are derivatives of naphthalene, anthracene, perylene, terylene, quarterylene, and also diketopyrrolopyrrole dyes, perinone dyes, cumarin dyes, isoindoline and isoindolinone dyes, porphyrin dyes, phthalocyanine and naphthalocyanine dyes; and

UV absorbers: in particular compounds from groups a to g mentioned below

a) 4,4-diarylbutadienes,
b) cinnamic esters,
c) benzotriazoles,
d) hydroxybenzophenones,
e) diphenylcyanoacrylates,
f) oxamides,
g) 2-phenyl-1,3,5-triazines.

Group a) of the 4,4-diarylbutadienes includes, for example, compounds of the formula A.

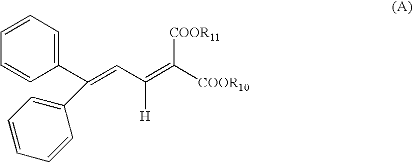

The compounds are known from EP-A-916 335. The substituents R₁₀ and/or R₁₁ are preferably C₁-C₈-alkyl and C₅-C₈-cycloalkyl.

Group b) of the cinnamic esters includes, for example, 2-isoamyl 4-methoxycinnamate, 2-ethylhexyl 4-methoxycinnamate, methyl α-methoxycarbonylcinnamate, methyl α-cyano-β-methyl-p-methoxycinnamate, butyl α-cyano-β-methyl-p-methoxycinnamate and methyl α-methoxycarbonyl-p-methoxycinnamate.

Group c) of the benzotriazoles includes, for example, 2-(2′-hydroxyphenyl)benzotriazoles, such as 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2′-(3′,5′-di-tert-amyl-2′-hydroxyphenyl)-benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzo-triazole, 2-(3′-tert-butyl-2′-hydroxy-5′-(2-methoxycarbonylethyl)phenyl)-5-chlorobenzo-triazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of the esterification of 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃]₂, where R=3′-tert-butyl-4′-hydroxy-5′-2H-benzotriazol-2-ylphenyl and mixtures thereof.

Group d) of the hydroxybenzophenones includes, for example, 2-hydroxybenzophenones, such as 2-hydroxy-4-methoxybenzophenone, 2,2′-dihydroxy-4-methoxybenzophenone, 2,4-dihydroxybenzophenone, 2,2′,4,4′-tetrahydroxybenzophenone, 2,2′-dihydroxy-4,4′-dimethoxybenzophenone, 2-hydroxy-4-(2-ethylhexyloxy)benzophenone, 2-hydroxy-4-(n-octyloxy)benzophenone, 2-hydroxy-4-methoxy-4′-methylbenzophenone, 2-hydroxy-3-carboxybenzophenone, 2-hydroxy-4-methoxybenzophenone-5-sulfonic acid and its sodium salt, 2,2′-dihydroxy-4,4′-dimethoxybenzophenone-5,5′-bissulfonic acid and its sodium salt.

Group e) of the diphenylcyanoacrylates includes, for example, ethyl 2-cyano-3,3-diphenylacrylate which is commercially available, for example, under the name Uvinul® 3035 from BASF AG, Ludwigshafen, 2-ethylhexyl 2-cyano-3,3-diphenylacrylate, which is commercially available, for example, as Uvinul® 3039 from BASF AG, Ludwigshafen, and 1,3-bis[(2′-cyano-3′,3′-diphenylacryloyl)oxy]-2,2-bis{[2′-cyano-3′,3′-diphenylacryloyl)oxy]methyl}propane which is commercially available, for example, under the name Uvinul® 3030 from BASF AG, Ludwigshafen.

Group f) of the oxamides includes, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, and also mixtures of ortho-, para-methoxy-disubstituted oxanilides and mixtures of ortho- and para-ethoxy-disubstituted oxanilides.

Group g) of the 2-phenyl-1,3,5-triazines includes, for example, 2-(2-hydroxyphenyl)-1,3,5-triazines, such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropoxy)-phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine and 2-(2-hydroxyphenyl)-4-(4-methoxyphenyl)-6-phenyl-1,3,5-triazine.

In addition to the components mentioned above, the aqueous active compound compositions according to the invention may also comprise conventional surface-active substances and other additives. The surface-active substances include surfactants, dispersants and wetting agents. The other additives include in particular thickeners, antifoams, preservatives, antifreeze agents, stabilizers, etc.

Suitable in principle are anionic, cationic, nonionic and amphoteric surfactants, which include polymer surfactants and surfactants having heteroatoms in the hydrophobic group.

The anionic surfactants include, for example, carboxylates, in particular alkali metal, alkaline earth metal and ammonium salts of fatty acids, for example potassium stearate, which are usually also referred to as soaps; acyl glutamates; sarcosinates, for example sodium lauroyl sarcosinate; taurates; methylcelluloses; alkyl phosphates, in particular alkyl esters of mono- and diphosphoric acid; sulfates, in particular alkyl sulfates and alkyl ether sulfates; sulfonates, furthermore alkylsulfonates and alkylarylsulfonates, in particular alkali metal, alkaline earth metal and ammonium salts of arylsulfonic acids and of alkyl-substituted arylsulfonic acids, alkylbenzenesulfonic acids, such as, for example, ligno- and phenolsulfonic acid, naphthalene- and dibutylnaphthalenesulfonic acids, or dodecylbenzenesulfonates, alkylnaphthalenesulfonates, alkyl methyl ester sulfonates, condensates of sulfonated naphthalene and derivatives thereof with formaldehyde, condensates of naphthalenesulfonic acids, phenol- and/or phenolsulfonic acids with formaldehyde or with formaldehyde and urea, mono- or dialkyl sulfosuccinates; and also protein hydrolyzates and lignosulfite waste liquors. The abovementioned sulfonic acids are advantageously used in the form of their neutral or, if appropriate, basic salts.

The cationic surfactants include, for example, quaternized ammonium compounds, in particular alkyltrimethylammonium halides, dialkyldimethylammonium halides, alkyltrimethylammonium alkyl sulfates, dialkyldimethylammonium alkyl sulfates, and also pyridine and imidazoline derivatives, in particular alkylpyridinium halides.

The nonionic surfactants include, for example:
fatty alcohol polyoxyethylene esters, for example lauryl alcohol polyoxyethylene ether acetate,
alkyl polyoxyethylene ethers and alkyl polyoxypropylene ethers, e.g. of isotridecyl alcohol and fatty alcohol and fatty alcohol polyoxyethylene ethers,
alkylaryl alcohol polyoxyethylene ethers, for example octylphenol polyoxyethylene ether,
alkoxylated animal and/or vegetable fats and/or oils, for example corn oil ethoxylates, castor oil ethoxylates, tallow fat ethoxylates,
glycerol esters, such as, for example, glycerol monostearate,
fatty alcohol alkoxylates and oxoalcohol alkoxylates, in particular of the type RO—(R₁₈O)ᵣ(R₁₉O)ₛR₂₀ where R₁₈ and R₁₉ independently of one another=C₂H₄, C₃H₆, C₄H₈ and R₂₀═H, or C₁-C₁₂-alkyl, R═C₃-C₃₀-alkyl or C₆-C₃₀-alkenyl, r and s independently of one another are 0 to 50, where one of these must be other than 0, such as isotridecyl alcohol and oleyl alcohol polyoxyethylene ether,
alkylphenol alkoxylates, such as, for example, ethoxylated isooctylphenol, octylphenol or nonylphenol, tributylphenol polyoxyethylene ether,
fatty amine alkoxylates, fatty acid amide alkoxylates and fatty acid diethanolamide alkoxylates, in particular their ethoxylates,
sugar surfactants, sorbitol esters, such as, for example, sorbitan fatty acid esters (sorbitan monooleate, sorbitan tristearate), polyoxyethylene sorbitan fatty acid esters, alkyl polyglycosides, N-alkylgluconamides,
alkyl methyl sulfoxides,
alkyldimethylphosphine oxides, such as, for example, tetradecyldimethylphosphine oxide.

The amphoteric surfactants include, for example, sulfobetaines, carboxybetaines and alkyldimethylamine oxides, for example tetradecyldimethylamine oxide.

Other surfactants which may be mentioned here by way of example are perfluorosurfactants, silicone surfactants, phospholipids, such as, for example, lecithin or chemically modified lecithins, amino acid surfactants, for example N-lauroyl-glutamate.

Unless specified otherwise, the alkyl chains of the surfactants listed above are linear or branched radicals having usually 8 to 20 carbon atoms.

In one embodiment, the aqueous active compound composition according to the invention comprises not more than 10% by weight, preferably not more than 5% by weight and in particular not more than 3% by weight, for example from 0.01 to 5% by weight or from 0.1 to 3% by weight, of conventional surface-active substances, in each case based on the total amount of active compound and polymer composition. In this case, the conventional surface-active substances preferably do not constitute more than 5% by weight and in particular not more than 3% by weight, for example from 0.01 to 5% by weight or from 0.1 to 3% by weight, based on the total weight of the composition.

However, depending on the application, it may be advantageous to formulate the active compound compositions according to the invention with surface-active substances. In this case, the proportion of conventional surface-active substance is frequently in the range from 0.5 to 30% by weight, in particular in the range from 1 to 20% by weight, based on the total amount of active compound and polymer composition, or in the range from 0.2 to 20% by weight and in particular in the range from 0.5 to 15% by weight, based on the total weight of the formulated composition.

In spite of the fact that one of the advantages of the compositions according to the invention is their low content of volatile organic compounds, for some applications it may be desirable for the compositions according to the invention to be formulated with organic solvents, oils and fats, preferably solvents or oils and fats which are environmentally friendly or biocompatible, for example the water-miscible solvents mentioned above or solvents, oils or fats whose miscibility with water is only very limited, or which are not miscible with water, for example with one or more of the substances mentioned below:
paraffin oils, aromatic hydrocarbons and mixtures of aromatic hydrocarbons, for example xylenes, Solvesso 100, 150 or 200, and the like,
phenols and alkylphenols, for example phenol, hydroquinone, nonylphenol, etc.
ketones having more than 4 carbon atoms, such as cyclohexanone, isophorone, isopherone, acetophenone, acetonaphthone,
alcohols having more than 4 carbon atoms, such as acetylated lanolin alcohol, cetyl alcohol, 1-decanol, 1-heptanol, 1-hexanol, isooctadecanol, isopropyl alcohol, oleyl alcohol, benzyl alcohol,
carboxylic esters, for example dialkyl adipates, such as bis(2-ethylhexyl) adipate, dialkyl phthalates, such as bis(2-ethylhexyl) phthalate, alkyl acetates (also branched alkyl groups), such as ethyl acetate and ethyl acetoacetate, stearates, such as butyl stearate, glycerol monostearate, citrates, such as acetyltributyl citrate, furthermore cetyl octanoate, methyl oleate, methyl p-hydroxybenzoate, methyl tetradecanoate, propyl p-hydroxybenzoate, methyl benzoate, lactates, such as isopropyl lactate, butyl lactate and 2-ethylhexyl lactate,
vegetable oils, such as palm oil, rapeseed oil, castor oil and derivatives thereof, such as, for example, oxidized, coconut oil, cod liver oil, corn oil, soybean oil, linseed oil, olive oil, peanut oil, safflower oil, sesame oil, grapefruit oil, basil oil, apricot oil, ginger oil, geranium oil, orange oil, rosemary oil, macadamia oil, onion oil, mandarin oil, pine oil, sunflower oil,
hydrogenated vegetable oils, such as hydrogenated palm oil, hydrogenated rapeseed oil, hydrogenated soybean oil,
animal oils, such as pig fat oil, fish oils,
dialkylamides of medium- to long-chain fatty acids, for example Hallcomides, and also
vegetable oil esters, such as rapeseed oil methyl ester.

Suitable thickeners are compounds which confer a pseudoplastic flow behavior to the formulation, i.e. high viscosity at rest and low viscosity in the agitated state. Mention may be made, in this connection, for example, of polysaccharides or organic sheet minerals, such as Xanthan Gum® (Keizan® from Kelco), Rhodopol® 23 (Rhone Poulenc) or Veegum® (from R. T. Vanderbilt) or Attaclay® (from Engelhardt), Xanthan Gum® being preferred.

Antifoam agents suitable for the dispersions according to the invention are, for example, silicone emulsions (such as, for example, Silikon® SRE, from Wacker, or Rhodorsil® from Rhodia), long-chain alcohols, fatty acids, organofluorine compounds and mixtures thereof.

Bactericides can be added to stabilize the compositions according to the invention against attack by microorganisms. Suitable bactericides are, for example, Proxel® from ICI or Acticide®, RS from Thor Chemie and Kathon® MK from Rohm & Haas.

Suitable antifreeze agents are organic polyols, for example ethylene glycol, propylene glycol or glycerol. These are usually employed in amounts of not more than 10% by weight, based on the total weight of the active compound composition, so that the desired content of volatile compounds is not exceeded. In one embodiment of the invention, the proportion of volatile organic compounds different therefrom is preferably not more than 1% by weight, in particular not more than 1000 ppm.

If appropriate, the active compound compositions according to the invention may comprise 1 to 5% by weight of buffer, based on the total amount of the formulation prepared, to regulate the pH, the amount and type of buffer used depending on the chemical properties of the active compound or the active compounds. Examples of buffers are alkali metal salts of weak inorganic or organic acids, such as, for example, phosphoric acid, boric acid, acetic acid, propionic acid, citric acid, fumaric acid, tartaric acid, oxalic acid and succinic acid.

The invention furthermore provides solid active compound compositions comprising at least one amphiphilic polymer composition as described herein and at least one active compound and/or effect substance, finely divided in the polymer composition, having a solubility in water at 25° C./1013 mbar of less than 10 g/l and which is typically selected from the active compounds mentioned above. The solid active compound compositions according to the invention can be dispersed in water, yielding the aqueous active compound compositions according to the invention. Surprisingly, the aqueous active compound compositions obtained in this manner are also distinguished in that the active compounds are very finely divided in the continuous aqueous phase, where the particle sizes given above are obtained and substantially not exceeded.

The solid active compound compositions comprise the active compound and/or effect substance and the amphiphilic polymer composition generally in a weight ratio of from 1:10 to 3:1 and in particular in the range from 1:5 to 2:1.

The solid active compound compositions according to the invention can be obtained, for example, by drying an aqueous active compound composition according to the invention, by dissolving the active compound in an active compound melt or by dissolving the active compound and the amphiphilic polymer composition in a solvent and removing the solvent.

Preference is given to solid active compound compositions according to the invention which are obtained by drying the aqueous active compound compositions. These are solid materials which are usually obtained in the form of particles. Depending on the type of drying process, for example, powders or granules are obtained.

For drying, the volatile components, i.e. water and any solvents or volatile bases, are removed by customary methods. Methods that may be mentioned are in particular convection drying methods, such as spray drying, fluidized-bed drying, pneumatic drying, mill drying, belt drying and mixed forms of these drying methods, by contact drying processes, such as drum drying, cabinet or compartment drying, thin-layer drying, drying in a paddle dryer or in a rotary dryer, freeze drying and radiation drying. Such processes are familiar to the person skilled in the art, for example from C. M. van't Land “Industrial Drying Equipment” Marcel Decker, Inc. 1991; O. Krischer, W. Kast, K. Kröll, “Trocknungstechnik” [Drying techniques], Vol. 1 to 3, Springer-Verlag 1978, 1959 and 1989; K. Masters, “Spraydrying Handbook”, Longman Scientific and Technical; H. Uhlmann/Lothar Mörl, “Wirbelschicht/Sprühgranulat” [Fluidized-bed/spray granules], Springer-Verlag 2000. The aqueous active compound compositions are preferably dried at temperatures below the glass temperature of the polymer and in particular in the range from −20° C. to 100° C.

Depending on the nature of the active compound or effect substance present, the active compound or effect substance compositions according to the invention can be employed in a manner comparable per se in conventional formulations of the respective active compound or effect substance. For example, active compound compositions comprising at least one insecticidally, acaricidally or nematicidally active compound can be used for controlling harmful insects, acarids or nematodes. If the active compound compositions according to the invention comprise at least one fungicidally active compound, they can be used for controlling harmful fungi. If the active compound compositions according to the invention comprise a herbicidally active compound, they can be used for controlling weed grasses and the like.

Depending on the nature of the active compound, the compositions according to the invention are used in particular for protecting plants against attack by harmful organisms, such as insects, acarids, nematodes, or for protection against attack by phytopathogenic fungi and the like, or for seed treatment or in the protection of materials, for example for protecting lignocellulose materials, such as wood, against attack by harmful insects, such as wood-destroying beetles, termites, ants and the like, or against attack by wood-discoloring or wood-destroying fungi.

The compositions according to the invention can, of course, also be used in cosmetics or in medicine or in industrial applications.

The invention will now be illustrated in more detail using the examples below.

### I. PREPARATION OF THE POLYMER COMPOSITION

### I.1 Preparation Example 1

a) 4000 g of a methyl-terminated polyethylene oxide (number-average molecular weight 2000 dalton, KOH number 33 mg/g of solid substance) and 573 g of a commercially available biuret of hexamethylene diisocyanate (NCO content 22%, viscosity at 23° C. 4.0 Pa·s) were dissolved in 4573 g of tetrahydrofuran, and the solution was heated at 60° C. 0.08 g of dibutyltin dilaurate was added, and the reaction mixture was stirred at the same temperature until the NCO content of the mixture had fallen to 0.46%.

b) 1500 g of tetrahydrofuran were heated under reflux. Over a period of 2 hours, feed 1a comprising 1400.1 g of 2-(dimethylamino)ethyl methacrylate, 850.6 g of methyl methacrylate and 632.3 g of n-butyl methacrylate and feed 1b comprising 1500 g of tetrahydrofuran (THF), 15.59 g of azobisisobutyronitrile (AIBN) and 58.42 g of mercaptoethanol were added simultaneously, and the mixture was kept under reflux until the amount of monomer had decreased to less than 3% by weight of the original amount (determined by gas chromatography). 6859 of the reaction mixture from step a were then added and the mixture was stirred at 65° C. until the NCO content had decreased to 0%. The mixture was then diluted with 8573 g of tetrahydrofuran.

c) To the polymer solution from step b. Over a period of 30 min, 15 kg of water were then added and the tetrahydrofuran was distilled off under reduced pressure. This gave a 30% by weight strength aqueous dispersion of the polymer composition having a mean particle size (determined by dynamic light scattering at pH=7) of 244 nm.

### I.2 Preparation Example 2

a) 1500 g of tetrahydrofuran were heated under reflux. Over a period of 2 hours, feed 1a comprising 1112 g of 2-vinylpyridine, 1059.1 g of methyl methacrylate and 751.9 g of n-butyl methacrylate and feed 1b comprising 1500 g of tetrahydrofuran (THF), 18.59 g of azobisisobutyronitrile (AIBN) and 58.42 g of mercaptoethanol were added and the mixture was kept under reflux until the amount of monomer had decreased to less than 3% by weight of the original amount used (determined by gas chromatography). 6859 of the reaction mixture from example 1, step a, were then added, and the mixture was stirred at 65° C. until the NCO content had decreased to 0%. The mixture was then diluted with 8573 g of tetrahydrofuran.

b) Over a period of 30 min, 15 kg of water were added to the polymer solution obtained in this manner, and the tetrahydrofuran was distilled off under reduced pressure. This gave a 30% by weight strength aqueous dispersion of the polymer composition having a mean particle size (determined by dynamic light scattering at pH=7) of 196 nm.

### I.3 Preparation Example 3

a) 1444 g of tetrahydrofuran (THF) were heated under reflux. Over a period of two hours, feed 1a comprising 1631.6 g of 3-(N,N-dimethylamino)propyl methacrylate (DMAPMA), 719.8 g of methyl methacrylate (MMA) and 460.7 g of 2-phenoxyethyl acrylate (POEA) and feed 1b comprising 1444 g of THF, 18.57 g of azobisisobutyronitrile (AIBN) and 58.36 g of mercaptoethanol were added simultaneously and the mixture was then heated under reflux until the amount of monomer had decreased to less than 3% by weight of the original amount used (determined by gas chromatography). 6859 g of the reaction mixture from example 1, step a, were then added, and the mixture was then heated at 65° C. until the isocyanate content had decreased to 0%. The reaction mixture was then diluted with 7760 g of THF.

Over a period of 30 minutes, 15 kg of water were added to the polymer solution obtained in this manner, and the THF was then distilled off under reduced pressure. This gave a 30% by weight strength aqueous dispersion of the polymer composition having a mean particle size (determined by dynamic light scattering at pH=7) of <20 nm.

### II. PREPARATION OF AQUEOUS ACTIVE COMPOUND PREPARATIONS ACCORDING TO THE INVENTION

### II.1 Analysis:

The viscosities stated here were determined in a rotation viscometer according to DIN 53019-2.

The mean particle diameters were determined by the method of static light scattering using a dilute sample of the aqueous active compound formulation at 20° C.

To test the storage stability, the aqueous active compound compositions were stored at room temperature for 2 weeks, at 54° C. for 2 weeks and at 5° C. for 2 weeks. Moreover, the active compound compositions were frozen and thawed. The samples are storage-stable if neither sedimentation nor creaming is observed under these conditions.

### II.2 General preparation procedures

1. Solubilization Method (Liquid Active Compounds and Active Compound Melts):
10 g of active compound are stirred into 90 g of an aqueous dispersion of a polymer composition comprising 30 g of polymer, at a temperature at which the active compound is present as a low-viscosity melt (for example at from 60 to 80° C.). Depending on the viscosity of the polymer solution and the active compound melt, stirring is carried out using a magnetic stirrer or an Ultraturrax. The time required until the solubilization equilibrium is reached depends on the polymer composition and on the active compound and can be a few seconds, but also a number of hours. The solubilization equilibrium is reached when the active compound is uniformly distributed in the mixture and no change of particle size is observed even when more energy is introduced.

2. Phase Inversion Method:
13.33 g of a 15% strength solution of the liquid or solid active compound in THF are mixed with 20 g of the 30% strength polymer solution in tetrahydrofuran. Water is then added with stirring, and the organic solvent is subsequently removed by distillation. The amount of water added is such that the resulting aqueous formulation comprises 10% by weight of active compound and 30% by weight of polymer.

3. Method of Solid Solution:
0. g of the polymer composition (polymer content >95% by weight) and 0.1 of the active compound are dissolved in about 20 ml of an organic solvent (preferably tetrahydrofuran, dimethylformamide). The solvent is then removed completely (for example on a rotary evaporator), so that a solid solution of hydrophobic active compound and polymer composition remains. A buffered aqueous solution (100 ml, pH 6.8) is added, and the mixture is stirred for 24 hours. After filtration, the solution is analyzed by HPLC (UV detector), and the active compound concentration is determined.

4. Nozzle Precipitation:
Using two pumps, a 30% strength aqueous polymer dispersion and a 40% strength active compound/THF solution are mixed in a mixing apparatus via a mixing nozzle. The flow rate of the polymer dispersion is 12 kg/h, the flow rate of the THF solution is 3 kg/h, so that the total flow rate is 15 kg/h. The mixing apparatus is comparable to the apparatus described in “Handbook of Industrial Crystallization” (A. S. Myerson, 1993 Butterworth-Heinemann, page 139, ISBN 0-7506-9155-7). This gave a light-yellow milky suspension comprising 8% of active compound and 24% of polymer. The THF and some of the water are then removed by distillation, so that an aqueous nanoparticulate formulation comprising 10% of active compound and 30% of polymer is formed.

### II.3 Formulation Example 1

### Solubilization of Pyraclostrobin with the Polymer Composition from Preparation Example 1b by the Phase Inversion Method (General Procedure 2)

13.33 g of a 15% strength solution of pyraclostrobin in THF were mixed with 20 g of polymer solution in THF (30% strength) from example 1b. With stirring, water was then added, and the THF was removed under reduced pressure. The amount of water was chosen such that the resulting aqueous formulation comprised 10% by weight of active compound and 30% by weight of the polymer composition.

The resulting active compound composition was homogeneous, virtually visually transparent and could be diluted with water (both deionized water and water 10° d[German hardness]) without any sedimentation or crystallization of the active compound taking place.

The other active compounds listed in table 1 can also be formulated in an analogous manner.

TABLE 1

| Active compound | Solubility in distilled water [mg/l] |
|---|---|
| Epoxyconazole | 6.63 |
| Boscalid | 4.6 |
| Pyraclostrobin | 2.4 |
| Metconazole | 15 |
| alpha-Cypermethrin | 0.01 |

### II.4 Formulation Example 2

### Redispersion of a Solid Active Compound Formulation from Formulation Example 1

A 40% strength aqueous liquid formulation of pyraclostrobin (formulation example 2) was freeze-dried. The solid formulation obtained was stable for months (visually, no active compound crystals could be detected) and could be diluted with water (both with deionized water and water 10° d) without any sedimentation or crystallization of the active compound taking place.

### II.5 Formulation Example 3

### Solubilization of Pyraclostrobin with the Polymer Composition from Preparation Example 1b by the Solid Solution Method (General Procedure 3)

Using the solid solution method, pyraclostrobin was formulated with the polymer composition from preparation example 1b. The solid solution formed was stable for at least several months (visually, no active compound crystals were detectable) and could be diluted with water (both with deionized water and water 10° d) without any sedimentation or crystallization of the active compound taking place.

### II.6 Formulation Example 4

### Solubilization of Pyraclostrobin with the Polymer Composition from Preparation Example 1b Using the Solubilization Method (General Procedure 1)

The resulting active compound composition was homogeneous, virtually visually transparent, sedimentation-stable for at least several months and could be diluted with water (both with deionized water and water 10° d) without any sedimentation or crystallization of the active compound taking place.

### II.7 Formulation Example 5

### Solubilization of Metconazole with the Polymer Composition from Preparation Example 2b by the Phase Inversion Method (General Procedure 2)

13.33 g of a 15% strength solution of metconazole in THF were mixed together with 20 g of the 30% strength polymer solution in THF from example 1b. With stirring, water was then added, and the THF was removed under reduced pressure. The amount of water was chosen such that the resulting aqueous formulation comprised 10% by weight of active compound and 30% by weight of the polymer composition.

The resulting active compound composition was homogeneous, virtually visually transparent and could be diluted with water (both with deionized water and water 10° d) without any sedimentation or crystallization of the active compound taking place.

The other active compounds listed in table 1 can also be formulated in an analogous manner.

### II.8 Formulation Example 6

### Redispersion of a Solid Formulation which Had been Prepared from Formulation Example 5

A 40% strength liquid formulation of pyraclostrobin (formulation example 5) was freeze-dried. The solid formulation obtained was stable for months and could be diluted with water (both with deionized water and water 10° d) without any sedimentation or crystallization of the active compound taking place.

### II.9 Formulation Example 7

### Solubilization of Pyraclostrobin with the Polymer Composition from Preparation Example 2b by the Solid Solution Method (General Procedure 3)

Using the solid solution method, pyraclostrobin was solubilized with the polymer composition from preparation example 2b. The solid solution formed was stable for at least several months (visually, no active compound crystals were detectable) and could be diluted with water (both with deionized water and water 10° d) without any sedimentation or crystallization of the active compound taking place.

### II.10 Formulation Example 8

### Solubilization of Pyraclostrobin with the Polymer Composition from Preparation Example 2b Using the Solubilization Method (General Procedure 1)

The resulting active compound composition was homogeneous, virtually visually transparent, sedimentation-stable for at least several months and could be diluted with water (both with deionized water and water 10° d) without any sedimentation or crystallization of the active compound taking place.

### II.11 Formulation Example 9

### Solubilization of Metconazole with the Polymer Composition from Preparation Example 2b by the Phase Inversion Method (General Procedure 2)

13.33 g of a 15% strength solution of metconazole in tetrahydrofuran were mixed together with 20 g of the 30% strength polymer solution in tetrahydrofuran from example 1b and a nonionic surfactant (see table 3). With stirring, water was then added and the tetrahydrofuran was removed under reduced pressure. The amount of water was chosen such that the resulting aqueous formulation comprised 10% by weight of active compound and 30% by weight of the polymer composition.

TABLE 3
Active compound formulations comprising
a low-molecular-weight compound

| Formulation | Surfactant | Amount of surfactant [g] |
|---|---|---|
| 9a | A | 1 g |
| 9b | A | 6 g |
| 9c | B | 1 g |
| 9d | B | 6 g |

A: ethoxylated isotridecanol having a degree of ethoxylation of 8
B: ethoxylated C₉-C ₁₁-alkanol having a degree of ethoxylation of 3

The active compound compositions obtained were homogeneous, virtually visually transparent and could be diluted with water (both with deionized water and water 10° d) without any sedimentation or crystallization of the active compound taking place.

### III APPLICATION TEST

### III.1 Assessment of the Fungicidal Activity

The aqueous active compound composition from formulation example 5 (metconazole) and a commercial formulation of the same active compound metconazole were compared with respect to their activity against brown rust (Puccinia recondite) on wheat plants in a greenhouse according to the following procedure:

Curative activity against brown rust of wheat caused by

Puccinia recondita

The active compound metconazole was prepared as a stock solution of a concentration of 64 ppm of active compound and then diluted with water to the active compound concentration given below (table 4).

Leaves of potted wheat seedlings of the cultivar “Kanzler” were inoculated with a spore suspension of brown rust (Puccinia recondita). The pots were then placed in a chamber with high atmospheric humidity (90 to 95%) and at 20 to 22° C. for 24 hours. During this time, the spores germinated and the germ tubes penetrated into the leaf tissue. The next day, the infected plants were sprayed to runoff point with an aqueous suspension having the concentration of active compound stated below. The suspension had been prepared as described above. After the spray coating had dried on, the test plants were cultivated in a greenhouse at temperatures between 20 and 22° C. and at 65 to 70% relative atmospheric humidity for 7 days. The extent of the rust fungus development on the leaves was then determined.

The results of the biological test are summarized in table 4. The results show that polymer-stabilized active compound has a fungicidal activity which is on the same level as that of commercial products.

TABLE 4

| Application | Infection [%] | Infection [%] | Infection [%] | Infection [%] |
|---|---|---|---|---|
| rate | Formulation | Formulation | Formulation | Conventional |
| [ppm] | example 5 | example 9c | example 9d | formulation ¹⁾ |
| 64 | 0 | 0 | 0 | 0 |
| 32 | 0 | 0 | 0 | 3 |
| 16 | 6 | 6 | 0 | 10 |
| 8 | 15 | 37 | 14 | 35 |
| 4 | 77 | 63 | 63 | 70 |

¹⁾ composition of the conventional formulation:
200 g/l of metconazole
70 g/l of antifreeze
30 g/l of nonionic dispersant
20 g/l of anionic dispersant
2 g/l of thickener
2 g/l of biocide
in 1 l of aqueous formulation

1. A polymer composition, obtained by reacting
a) at least one polymer P1 which carries functional groups R1 which are reactive toward isocyanate groups and which is constructed of ethylenically unsaturated monomers M1, where the monomers M1 comprise more than 20% by weight, based on the total amount of monomers M1, of monomers M1a having at least one functional group FG selected from the group consisting of tertiary amino groups, imino groups, carboxamide groups, nitrile groups, lactam groups, keto groups, aldehyde groups, urea groups, polyether groups, carboxyl groups, sulfonyl groups, hydroxysulfonyl groups and sulfonamide groups,
b) at least one poly-C₂-C₄-alkylene ether P2 which carries functional groups R2 which are reactive toward isocyanate groups,
c) with at least one compound V which contains isocyanate groups and, with respect to the isocyanate groups, has a functionality of at least 1.5.

2. The polymer composition according to claim 1 wherein the polymer P1 has, with respect to the functional groups R1, a functionality F1 in the range from 0.3 to 3.

3. The polymer composition according to claim 1 wherein the polymer P1 comprises:
a1) >20 to 90% by weight, based on the total amount of monomers M1, of monoethylenically unsaturated monomers M1a;
a2) 10 to <80% by weight, based on the total amount of monomers M1, of monomers M1b whose solubility in water at 25° C. is less than 30 g/l and which are different from the monomers M1a; and
a3) 0 to 20% by weight, based on the total amount of monomers M1, of ethylenically unsaturated monomers M1c which are different from the monomers M1a and M1b.

4. The polymer composition according to claim 3 wherein the monomers M1b are selected from monomers of the formula I 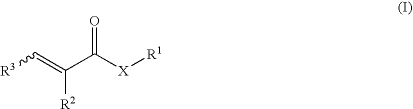
wherein
X is oxygen or a group N—R⁴;
R¹ is C₁-C₂₀-alkyl, C₅-C₁₀-cycloalkyl, phenyl, phenyl-C₁-C₄-alkyl or phenoxy-C₁-C₄-alkyl;
R² is hydrogen or C₁-C₄-alkyl;
R³ is hydrogen or C₁-C₄-alkyl; and
R⁴ is hydrogen or C₁-C₄-alkyl.

5. The polymer composition according to claim 3 wherein the monomers M1a are selected from the group consisting of
amides and C₁-C₄-alkyloxyalkylamides of monoethylenically unsaturated C₃-C₈-monocarboxylic acids;
monoethylenically unsaturated nitrites;
N-vinylamides of aliphatic, cycloaliphatic or aromatic carboxylic acids;
N-vinyllactams having 5 to 7 ring atoms;
vinyl-substituted nitrogen heteroaromatics;
monoethylenically unsaturated monomers which carry urea groups;
monoethylenically unsaturated monomers which have aldehyde or keto groups; and
monoethylenically unsaturated monomers having a primary, secondary or tertiary amino group.

6. The polymer composition according to claim 1, wherein the polymer P1 has a number-average molecular weight in the range from 500 to 20 000 dalton.

7. The polymer composition according to claim 1, wherein the poly-C₂-C₄-alkylene ether P2 comprises at least 70% by weight of ethylene oxide groups.

8. The polymer composition according to claim 1, wherein the poly-C₂-C₄-alkylene ether P2 has, with respect to the functional groups R2, a functionality F2 in the range from 0.5 to 3.0.

9. The polymer composition according to claim 1, wherein the poly-C₂-C₄-alkylene ether P2 has a number-average molecular weight in the range from 500 to 20 000 dalton.

10. The polymer composition according to claim 1, wherein a weight ratio of P1:P2 of the polymer P1 and the poly-C₂-C₄-alkylene ether P2 is in the range from 1:10 to 10:1.

11. A process for preparing an amphiphilic polymer composition according to claim 1, comprising reacting
i) at least one polymer P1 and
ii) at least one poly-C₂-C₄-alkylene ether P2 with
iii) at least one compound V which contains isocyanate groups and, with respect to the isocyanate groups, has a functionality of at least 1.5.

12. The process according to claim 11 wherein the polymer P1 and the poly-C₂-C₄-alkylene ether P2 are reacted successively with the compound V.

13. The process according to claim 11 wherein the polymer P1 and the poly-C₂-C₄-alkylene ether P2 are reacted in one step with the compound V.

14. A polymer composition according to claim 1 for stabilizing active compounds and/or effect substances wherein the active compound and/or effect substance has a solubility in water at 25° C./1013 mbar of less than 10 g/l.

15. The polymer composition according to claim 14 wherein the active compound and/or effect substance has a solubility in water at 25° C./1013 mbar of less than 5 g/l.

16. The composition according to claim 15 wherein the active compound and/or effect substance has a solubility in water at 25° C./1013 mbar of less than 1 g/l.

17. An active compound composition comprising at least one active compound and/or effect substance having a solubility in water at 25° C./1013 mbar of less than 10 g/l and at least one polymer composition according to claim 1.

18. An aqueous active compound composition comprising an aqueous medium as continuous phase and at least one active compound and/or effect substance, solubilized or dispersed in the continuous phase, having a solubility in water at 25° C./1013 mbar of less than 10 g/l and at least one amphiphilic polymer composition according to claim 1.

19. The active compound composition according to claim 18 wherein the active compounds and/or effect substances solubilized or dispersed in the aqueous phase comprise aggregates or particles whose mean particle size, determined by dynamic light scattering, does not exceed a value of 300 nm.

20. The active compound composition according to claim 17 wherein a weight ratio of the active compound and/or effect substance and the polymer composition is from 1:10 to 3:1.

21. The active compound composition according to claim 17 wherein a content of volatile organic compounds is less than 10% by weight, based on the total weight of the composition.

22. A process for preparing an active compound composition according to claim 17, comprising preparing a homogeneous, nonaqueous mixture of the amphiphilic polymer composition and at least one active compound and/or effect substance.

23. A process for preparing an aqueous active compound composition according to claim 18, comprising:
a) preparing a homogeneous nonaqueous mixture comprising amphiphilic polymer composition and active compound and/or effect substance, and
b) dispersing the resulting mixture with water.

24. A process for preparing an aqueous active compound composition according to claim 18, comprising:
a) preparing a solution of active compound and/or effect substance and, if appropriate, amphiphilic polymer composition in an organic solvent having a boiling point below that of water and
b) mixing the solution of the active compound and/or effect substance with water or an aqueous solution comprising the amphiphilic copolymer and
c) removing the organic solvent.

25. A process for preparing an aqueous active compound composition according to claim 18, comprising: incorporating the active compound and/or the effect substance into an aqueous solution of the amphiphilic polymer composition, at a temperature above the melting point of the active compound and/or effect substance.

26. A solid active compound composition, comprising at least one amphiphilic polymer composition according to claim 1 and at least one active compound and/or effect substance, having a solubility in water at 25° C./1013 mbar of less than 10 g/l wherein the at least one active compound and/or effect substance is finely divided in the polymer composition.

27. The solid active compound composition according to claim 26 wherein a weight ratio of active compound and/or effect substance and the polymer composition is from 1:10 to 3:1.

28. A solid active compound composition, obtained by drying a liquid, active compound composition according to claim 18.
